(19) United States
(12) Patent Application Publication
(10) Pub. No.: US 2008/0176117 A1
(43) Pub. Date: Jul. 24, 2008

(54) Fuel Cell System and Fuel Cell System Control Method

(75) Inventor: Yuichi Koike, Atsugi-shi (JP)

Correspondence Address: YOUNG & BASILE, P.C., 3001 WEST BIG BEAVER ROAD, SUITE 624, TROY, MI, 48084, US

(73) Assignee: NISSAN MOTOR CO., LTD., Yokohama-shi, Kanagawa (JP)

(21) Appl. No.: 11/815,286

(22) PCT Filed: Mar. 17, 2006
(86) PCT No.: PCT/IB06/00599

§ 371 Date: Aug. 1, 2007

(30) Foreign Application Priority Data
Mar. 29, 2005 (JP) 2005-096095
Mar. 29, 2005 (JP) 2005-096116

(51) Int. Cl. H01M 8/04

(52) U.S. Cl. 429/14; 429/25; 429/23; 429/24

(57) ABSTRACT

A fuel cell system and control method that accurately estimates the idle return time and/or auxiliary device power consumption that changes in accordance with environmental conditions. A fuel cell system comprising fuel cell 19 that generates power by supplying fuel gas containing hydrogen and oxidant gas containing oxygen, idle stopping means 62 that stops power generation of fuel cell 19, which is in idle operation, and puts it in an idle stopped state, atmospheric pressure detection means 61 that detects the atmospheric pressure of the periphery of the fuel cell, and idle return time estimation means 63 that estimates the idle return time from the time at which the fuel cell that is in the idle stopped state starts the start-up operation until it returns to idle operation based on the atmospheric pressure detected by the atmospheric pressure detection means.

### CROSS-REFERENCE TO RELATED APPLICATIONS

The present application claims priority to Japanese Patent Application No. 2005-096116, filed on Mar. 29, 2005, and Japanese Patent Application No. 2005-096095, filed on Mar. 29, 2005, the entire contents of both of which are expressly incorporated by reference herein.

### TECHNICAL FIELD OF THE INVENTION

The present invention relates to a fuel cell system and control method thereof, and especially relates to technology for estimating the time required to return an auxiliary device of a fuel cell system and the stopped power generation of a fuel cell stack from an idle stopped state to a predetermined idle state.

### BACKGROUND

In light of environmental problems in recent years, especially the problem of global warming due to carbon dioxide and atmospheric pollution caused by the exhaust gases of automobiles, fuel cell technology has gained popularity as an electric or motive power source that enables clean emissions and has a high energy efficiency. A fuel cell system is an energy converting system that supplies a fuel gas containing hydrogen with an oxidant gas of air or the like to generate an electrochemical reaction that converts chemical energy into electrical energy.

A fuel cell vehicle will normally equip an electrical storage device such as a battery or a capacitor to supplement the response of the fuel cell to operate electrical machinery, such as a drive motor, by receiving a supply of electric power from the fuel cell or battery.

Conventionally, as disclosed in, for instance, Japanese Laid Open Patent Publication No. 2001-359204 and Japanese Laid Open Patent Publication No. 2004-056868, a fuel cell system is determined to be in a predetermined idle state when the charged state (residual capacity) of the electrical storage device and the state of the vehicle, such as the vehicle speed or the drive motor output, is in a predetermined state, and the generation of electricity by the oxidant gas supply device and the fuel cell stack is stopped, thereby creating an idle stop (idle stopped state). Further, when the charged state of the vehicle or electrical storage device is not in a predetermined state, the oxidant gas supply device operates to supply electrical power by restarting the fuel cell stack.

However, whenever the atmospheric pressure around the vehicle drops or there is a change (rise) in air temperature, the control required to restart the fuel cell stack needs to be corrected accordingly. For instance, performing a correction to increase the motor torque or revolution speed of a motor to drive each auxiliary device equipped in a fuel cell system inevitably increases the workload of each auxiliary device. Further, there are cases in which operational limits are necessary in order to protect each auxiliary device from a power surge or the like when a change in the environmental condition or state of the vehicle occurs, as described above. In such a case, the return time (idle return time) from the idle stopped state to idle electric generation may increase.

### SUMMARY

To resolve this problem, the present invention proposes a technology for accurately estimating the idle return time that changes in accordance with environmental conditions.

In order to resolve the aforementioned problem, the first characteristic of the present invention is that it is a fuel cell system comprising a fuel cell that generates power by supplying fuel gas containing hydrogen and oxidant gas containing oxygen, an idle stopping means that stops power generation of said fuel cell, which is in idle operation, and puts it in an idle stopped state, an atmospheric pressure detection means that detects the atmospheric pressure of the periphery of the fuel cell, and an idle return time estimation means that estimates the idle return time from the time at which the fuel cell that is in the idle stopped state starts the start-up operation until it returns to idle operation based on the atmospheric pressure detected by the atmospheric pressure detection means.

The second characteristic of the present invention is that it is a control method for a fuel cell system, wherein said fuel cell system is equipped with a fuel cell that generates power by supplying fuel gas containing hydrogen and oxidant gas containing oxygen; stops the power generation of the fuel cell, which is in idle operation, and puts it in an idle stopped state; detects the atmospheric pressure of the periphery of the fuel cell; and estimates the idle return time from the time at which the fuel cell that is in the idle stopped state starts the start-up operation until it returns to idle operation based on the atmospheric pressure.

According to the present invention, a fuel cell system and control method thereof can be proposed that accurately estimates the idle return time that changes in accordance with the environmental conditions by estimating the idle return time based on the atmospheric pressure.

### BRIEF DESCRIPTION OF THE DRAWINGS

FIG. 1 details a diagram showing the basic composition of an embodiment of the present invention.

FIG. 2 details a block diagram showing a PP system as the fuel cell system pertaining to Embodiment 1.

FIG. 3 details a more detailed block diagram showing the fuel cell system in FIG. 2.

FIG. 4 details a graph showing the relationship between the amount of power generated by the fuel cell stack and the supply flow rate of the oxidant gas.

FIG. 5 details a graph showing the relationship between the supply flow rate of the oxidant gas and the motor revolution speed of the oxidant gas supply device.

FIGS. 6A and 6B detail graphs showing the relationship between the correction in the motor revolution speed of the oxidant gas supply device and the amount of power generated by the fuel cell stack.

FIG. 7 details (a) a graph showing the relationship between the temperature (cooling water temperature) of the fuel cell stack and the I-V characteristics of the fuel cell stack; (b) a graph showing the relationship between the temperature (cooling water temperature) of the fuel cell stack and the correction coefficients of the I-V characteristics of the fuel cell stack.

FIG. 8 details (a) a graph showing the relationship between the total power generation time of the fuel cell stack and the I-V characteristics of the fuel cell stack; (b) a graph showing the correction coefficients of the I-V characteristics of the fuel cell stack based on the total power generation time of the fuel cell stack.

FIG. 9 details a graph showing the method used to estimate the I-V characteristics of the fuel cell stack.

FIG. 10 details (a) a graph showing the relationship between the ideal IV characteristics and the estimated value of the I-V characteristics of the fuel cell stack and the amount of idle power generation; (b) a graph showing the relationship between the estimated value of the IV characteristics and the supply flow rate of the oxidant gas.

FIG. 11 details a graph showing the relationship between the pressure ratio of the oxidant gas supply device and the operating load.

FIG. 12 details a flowchart showing the entire control method for the fuel cell system.

FIG. 13 details a flowchart showing the method used to correct the target flow rate of the oxidant gas supply device when in idle operation.

FIG. 14 details a flowchart showing the method used to determine whether or not a delay occurs in the idle return time of the oxidant gas supply device.

FIG. 15 details a flowchart showing the method used to calculate the supply flow rate of the oxidant gas supply device when in idle operation with consideration given to the estimated value of the I-V characteristics of the fuel cell stack.

FIG. 16 details a flowchart showing the method used to estimate the I-V characteristics of the fuel cell stack.

FIG. 17 details a graph showing the relationship between the supply flow rate of the oxidant gas and the supply flow rate of the pure water used for humidifying.

FIG. 18 details a graph showing the relationship between the supply flow rate of the pure water used for humidifying and the motor revolution speed of the pure water supply device.

FIGS. 19A and 19B detail graphs showing the relationship between the correction in the motor revolution speed of the pure water supply device and the amount of power generated by the fuel cell stack.

FIG. 20 details a graph showing the relationship between the pressure ratio of the pure water supply device and the operating load.

FIG. 21 details a flowchart showing the method used to determine whether or not a delay occurs in idle return time of the pure water supply device.

FIG. 22 details a graph showing the relationship between the power generated by the fuel cell stack and the supply flow rate of the cooling water.

FIG. 23 details a graph showing the relationship between the supply flow rate of the cooling water and the motor revolution speed of the cooling water supply device.

FIGS. 24A and 24B detail graphs showing the relationship between the correction in the motor revolution speed of the cooling water supply device and the amount of power generated by the fuel cell stack.

FIG. 25 details a graph showing the relationship between the pressure ratio of the cooling water supply device and the operating load.

FIG. 26 details a flowchart showing the method used to determine whether or not a delay occurs in idle return time of the cooling water supply device.

FIG. 27 details a diagram showing the basic composition of an embodiment of the present invention.

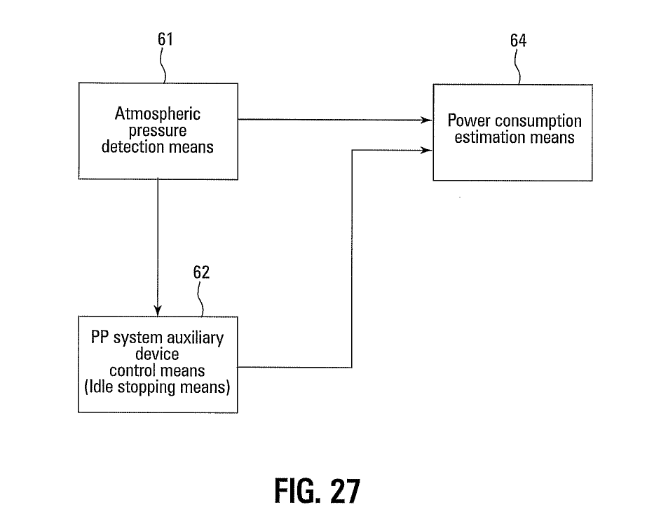

FIGS. 28A, 28B and 28C detail graphs showing the relationship between the correction in the motor revolution speed of the oxidant gas supply device, the required torque, and the electric power consumption.

FIG. 29 details a flowchart showing the entire control method for the fuel cell system.

FIGS. 30A, 30B and 30C detail graphs showing the relationship between the correction in the motor revolution speed of the pure water supply device, the required torque, and the electric power consumption.

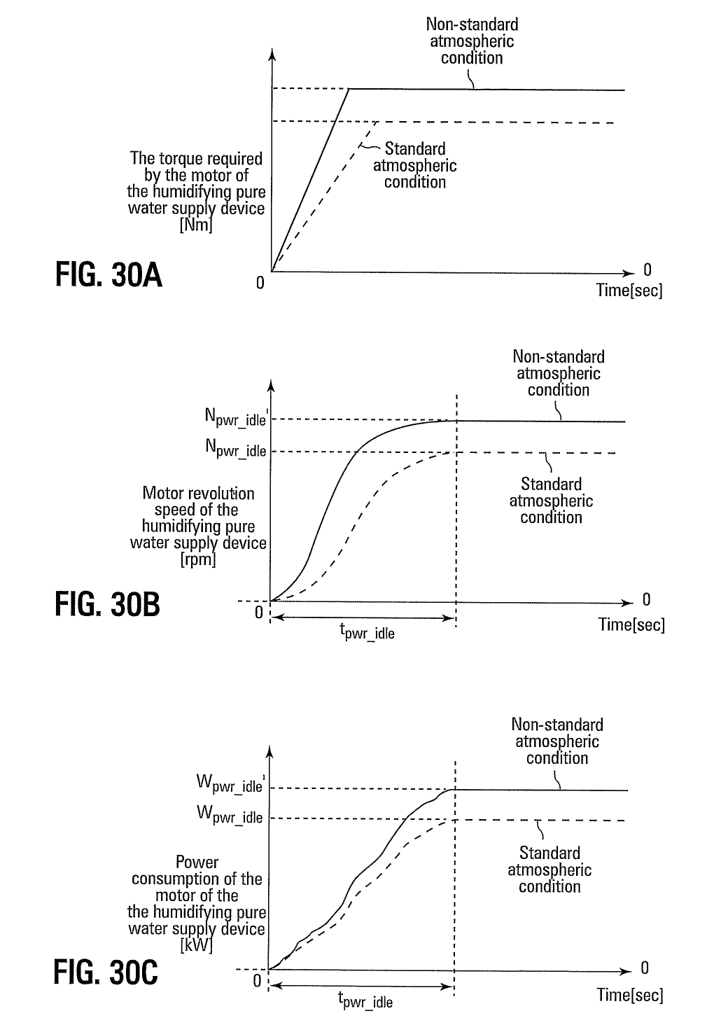

FIGS. 31A, 31B and 31C detail graphs showing the relationship between the correction in the motor revolution speed of the cooling water supply device, the required torque, and the electric power consumption.

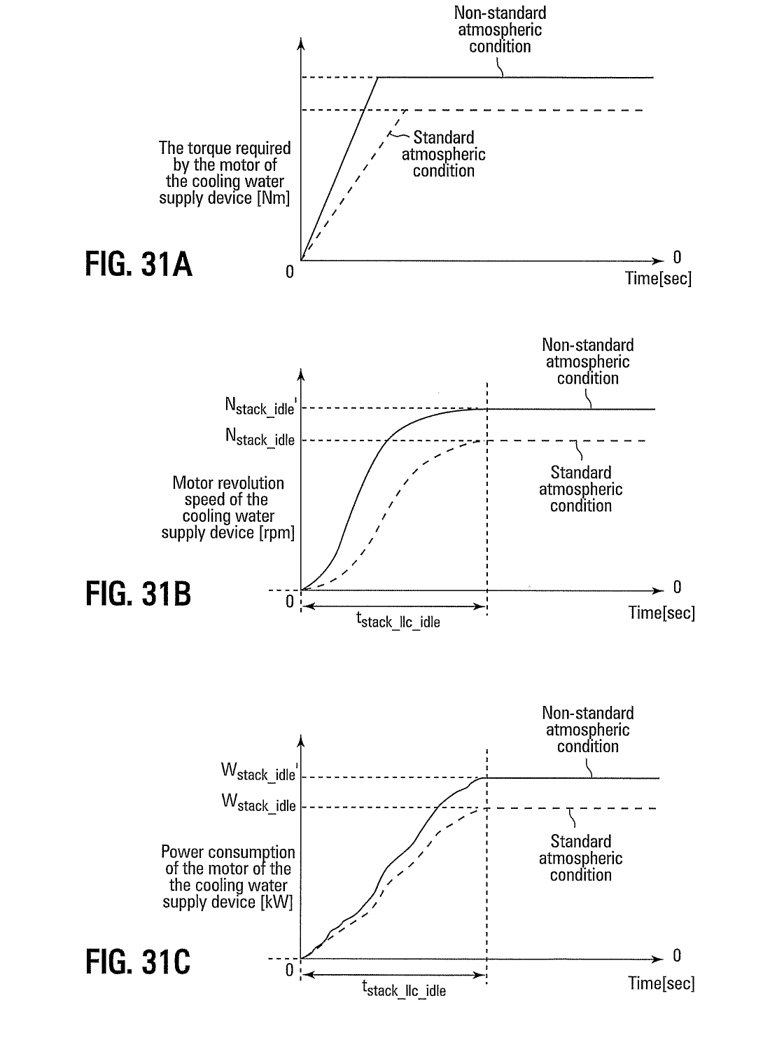

### EXPLANATION OF REFERENCE SYMBOLS

2 . . . Humidifier
3 . . . Oxidant gas supply device
4 . . . Variable valve
5 . . . Throttle
6 . . . Purge valve
7 . . . Pure water supply device
8 . . . Injector/Ejector
9 . . . Drive unit
10 . . . Oxidant gas pressure sensor
11 . . . Hydrogen pressure sensor
12 . . . Oxidant gas flow rate sensor
13 . . . Hydrogen flow rate sensor
14 . . . Controller
15 . . . Cell voltage detection device
16 . . . Atmospheric pressure sensor
17 . . . Temperature sensor
18 . . . High pressure hydrogen tank
19 . . . Fuel cell stack (fuel cells)
32 . . . Pure water radiator
33 . . . Radiator fan
34a, 34b, 38a, 38b . . . Three-way valves
35 . . . Cooling water radiator
36 . . . Radiator fan
37 . . . Cooling water supply device
39 . . . Pure water reservoir
40 . . . Cooling water reservoir
50, 51 . . . Pressure sensor
61 . . . Atmospheric pressure detection means
62 . . . PP system auxiliary device control means (Idle stopping means)
63 . . . Idle return time estimation means
64 . . . Power consumption estimation means

### DETAILED DESCRIPTION OF EMBODIMENTS OF THE INVENTION

A description of the Embodiment of the present invention is given below with reference to the drawings. The same or similar reference symbols will be used for those portions in the drawings that are the same or similar.

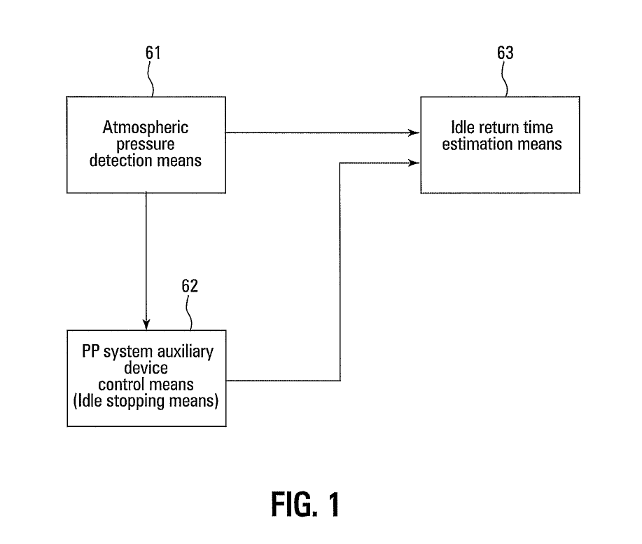

A description of the basic composition of the Embodiment of the present invention is given with reference to FIG. 1. The basic composition of the Embodiment of the present invention is a fuel cell system comprising a fuel cell that generates power by supplying fuel gas containing hydrogen and oxidant gas containing oxygen, and further comprising a PP system auxiliary device control means 62 as an idle stopping means that stops power generation of the fuel cell, which is in idle operation, and puts it in an idle stopped state, an atmospheric pressure detection means 61 that detects the atmospheric pressure of the periphery of the fuel cell, and an idle return time estimation means 63 that estimates the idle return time from the time at which the fuel cell that is in the idle stopped state starts the start-up operation until it returns to idle operation based on the atmospheric pressure detected by the atmospheric pressure detection means 61.

A “fuel cell” is herein a concept that includes: a “single cell” that is the basic compositional unit of a battery constituted by electrolytes interposed by a pair of electrodes (anode and cathode) to form a single assembly; a “cell stack” that is a laminated body of the single cell and is the basic compositional unit of a flat fuel cell that contains a separator, cooling plate, output terminal, and the like; and a “cell module” constituted by a plurality of cell stacks to obtain a predetermined output. Hereinafter, “fuel cell” is referred to as fuel cell stack.

“Idle operation” is a concept that includes no-load operation and standby operation (Japan Industry Standard Number: JISC8800) and that indicates a state of operation in which the minimum load required for operation (power generation) is supplied to itself without supplying power to an external load.

“Idle stopped state” is a concept that includes a state in which only power generation of the fuel cell stack from idle operation is stopped, and a state in which the operation of each auxiliary device constituting a fuel cell system, other than the fuel cell stack, is also stopped from idle operation. Further, a state in which the operation of each auxiliary device, other than the fuel cell stack, is also stopped is a concept that includes a state in which at least one operation is stopped from among any of: the auxiliary device that relates to the supply of fuel gas, the auxiliary device that relates to the supply of oxidant gas, or the auxiliary device that relates to the supply of water for humidifying the reaction gas.

The PP (power plant) system auxiliary device control means 62 controls the oxidant gas supply device as the auxiliary device based on the atmospheric pressure detected by atmospheric pressure detection means 61. The idle return time estimation means 63 estimates the idle return time of the fuel cell stack based on the atmospheric pressure detected by atmospheric pressure detection means 61 and the engine revolution speed command value of the auxiliary device (oxidant gas supply device) controlled by the PP system auxiliary device control means 62.

A fuel cell system is a device that converts energy held in a fuel into direct electrical energy, and it is a device that supplies fuel gas containing hydrogen to the positive electrode (anode) side of a pair of electrodes equipped to interpose an electrolytic film and supplies an oxidant gas containing oxygen to the negative electrode (cathode) side, thereby taking electrical energy from the electrodes by using a secondary electrochemical reaction that occurs on the surface of the electrolytic film of the pair of electrodes.

Anode Reaction: H₂→2H⁺+2e⁻

Cathode Reaction: 2H⁺+2e⁻+(½)O₂→H₂O

Known methods for supplying fuel gas to the anode are a method in which it is directly supplied from a hydrogen storage device and a method in which gas containing hydrogen is supplied by modifying fuel containing hydrogen. Natural gas, methanol, gasoline, and the like can be considered as fuels containing hydrogen. Generally, air is used as the oxidant gas to be supplied to the cathode.

A fuel cell system comprises: a fluid supply device that supplies fluid to the fuel cell due to the rotation of the motor, a flow rate calculation means that calculates the flow rate of the fluid that is required to realize idle operation, and a motor revolution speed calculation means that calculates the revolution speed of the motor for the fluid supply device that is required to realize the flow rate calculated by the flow rate calculation means. The idle return time estimation means 63 of FIG. 1 corrects the motor revolution speed calculated by the motor revolution speed calculation means based on the atmospheric pressure and estimates the idle return time based on the motor revolution speed for after the correction has been made.

Moreover, PP system auxiliary device control means 62 and idle return time estimation means 63, the flow rate calculation means, and the motor revolution speed calculation means shown in FIG. 1 can be realized by using a standard information processing device that provides a CPU, input device, output device, temporary storage device (main memory device), and the like, as a control device (controller).

### Embodiment 1

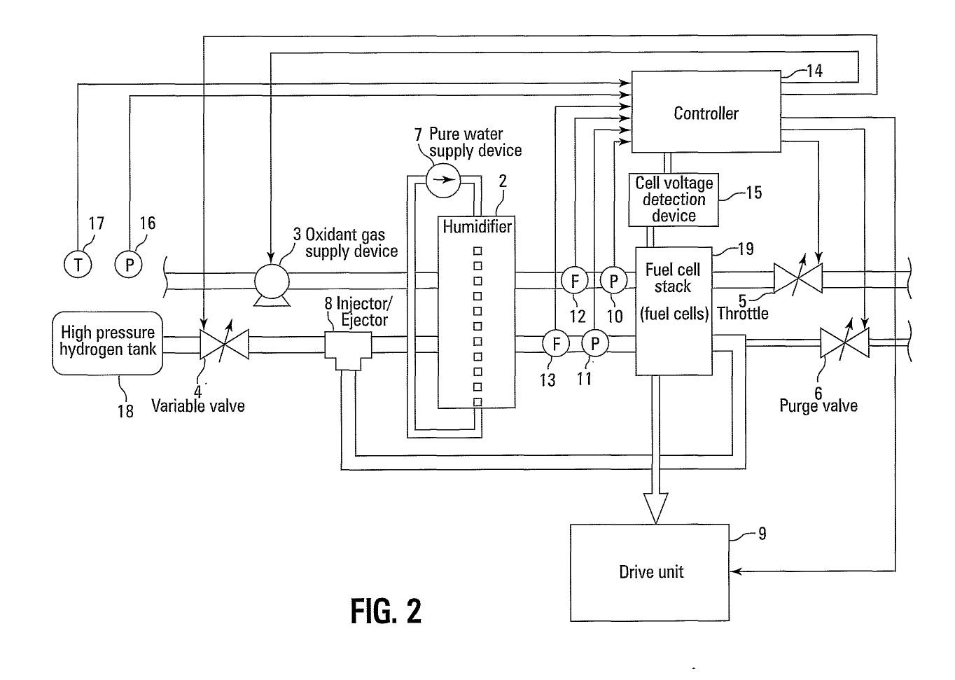

The fuel cell system provided as the PP system that relates to Embodiment 1, as shown in FIG. 2, comprises: a fuel cell stack 19; a humidifier 2 that humidifies the oxidant gas and hydrogen gas supplied to the fuel cell stack 19; an oxidant gas supply device 3 that pressure feeds oxidant gas; a variable valve 4 that controls the flow rate of the high pressure hydrogen; a throttle 5 that controls the pressure and flow rate of the oxidant gas; a purge valve 6 that externally discharges the hydrogen gas; a humidifying water supply device (pure water supply device) 7 that supplies water (i.e. pure water) for humidifying the oxidant gas and the hydrogen gas; an ejector 8 for circulating the unused hydrogen discharged from the fuel cell stack 19; a drive unit 9 that takes output from the fuel cell stack 19; an oxidant gas pressure sensor 10 that detects the oxidant gas pressure at the opening of the fuel cell stack 19; a hydrogen pressure sensor 11 that detects the hydrogen pressure at the opening of the fuel cell stack 19; an oxidant gas flow rate sensor 12 that detects the oxidant gas flow rate as it enters into the fuel cell stack 19; a hydrogen flow rate sensor 13 that detects the hydrogen flow rate as it enters into the fuel cell stack 19; a cell voltage detection device 15 that detects the electrical voltage of the single cell or single cell group from the fuel cell stack 19; and a controller 14 that loads the signals of each sensor and the output of the cell voltage detection device 15 and drives each actuator based on the embedded control software.

Oxidant gas supply device 3 is an oxidant gas system that sends compressed oxidant gas to humidifier 2. Humidifier 2 humidifies the oxidant gas with pure water supplied by pure water supply device 7. The humidified oxidant gas is fed to the cathode entrance of fuel cell stack 19.

The hydrogen gas, in a hydrogen gas system, is stored in a high-pressure state in high pressure hydrogen tank 18 with the flow rate thereof controlled by variable valve 4, while at the same time being set to a desired hydrogen pressure value in fuel cell stack 19. Further, the hydrogen gas mixes with a reflux amount consisting of the unused hydrogen gas discharged from fuel cell stack 19 at ejector 8, is sent to humidifier 2 where it is humidified by pure water supplied by pure water supply device 7 in the same manner as the oxidant gas at humidifier 2 before being sent to fuel cell stack 19.

Fuel cell stack 19 generates electric power by causing a reaction between hydrogen gas and oxidant gas that is sent to supply electric current (power) to an external system of a vehicle. The residual oxidant gas used in the reaction in fuel cell stack 19 is externally discharged from fuel cell stack 19. The oxidant gas pressure is controlled by the degree of the opening of throttle 5. Furthermore, the residual hydrogen gas used in the reaction at fuel cell stack 19 is externally discharged from fuel cell stack 19 while the unused hydrogen gas flows back up stream above humidifier 2 by ejector 8 for reuse in electrical generation.

Oxidant gas pressure sensor 10 detects the pressure of the oxidant gas in the cathode entrance of fuel cell stack 19. Oxidant gas flow rate sensor 12 detects the flow rate of the oxidant gas flowing into the cathode entrance of fuel cell stack 19. Hydrogen pressure sensor 11 detects the pressure of hydrogen gas in the cathode entrance of fuel cell stack 19. Hydrogen flow rate sensor 13 detects the flow rate of the hydrogen gas flowing into the anode entrance of fuel cell stack 19. Pressure sensor 16 functions as atmospheric pressure detection means 61, shown in FIG. 1, to detect the atmospheric pressure. Temperature sensor 17 detects the temperature of the air and is one example of an oxidant gas temperature detection means for detecting the temperature of the oxidant gas taken in by oxidant gas supply device 3. Cell voltage detection device 15 detects the electrical voltage of the single cell group (cell stack) consisting of a plurality of single cells or a single cell constituting of a fuel cell stack. These detected values are read into controller 14. Controller 14 not only controls oxidant gas supply device 3, throttle 5, and variable valve 4 so that the respective read values achieve their predetermined target values determined from the target power generation level at such time, but also controls these read values for commanding the output (electric current values) drawn from fuel cell stack 19 to drive unit 9.

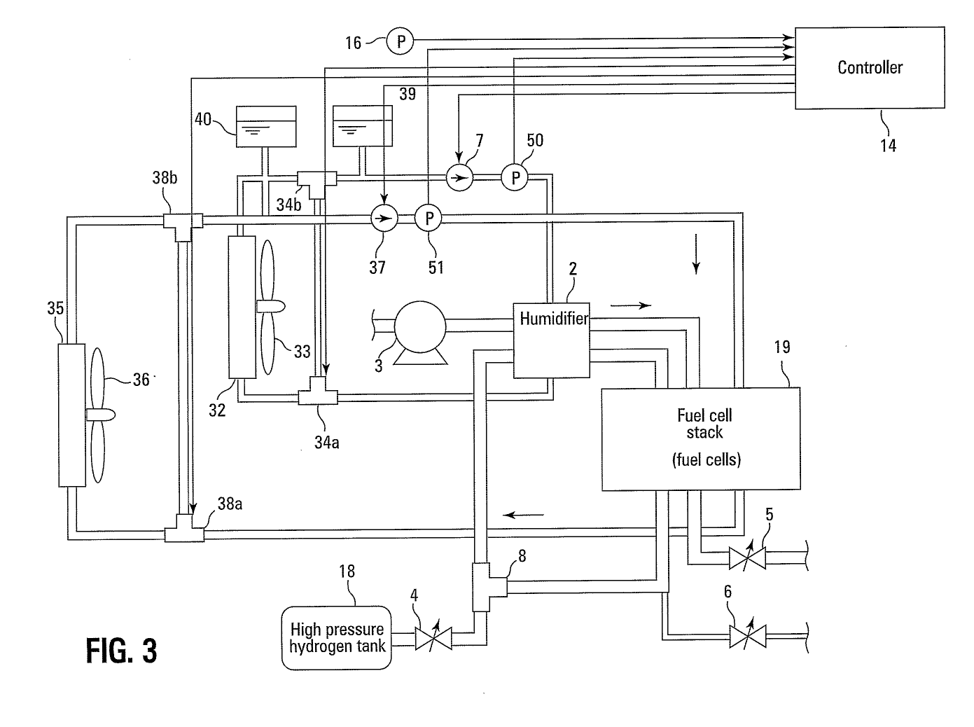

FIG. 3 is a schematic drawing of the device (auxiliary device) that relates to the fuel cell system of FIG. 2. The fuel cell system further comprises: pure water reservoir 39 that stores pure water for humidifying the fuel gas and the oxidant gas; 3-way valves 34a and 34b that adjust the flow rate of the pure water that passes through pure water radiator 32; pure water radiator 32 and radiator fan 33 that cool the pure water; cooling liquid supply device (cooling water supply device) 37 that supplies cooling liquid to fuel cell stack 19 for cooling fuel cell stack 19; cooling water supply reservoir 40 that stores cooling water; 3-way valves 38a and 38b that adjust the flow rate of the cooling water that passes through cooling water radiator 35; cooling water radiator 35 and radiator fan 36 that cool the cooling water; pressure sensor 16 that detects the atmospheric pressure; pressure sensor 50 that detects the discharge pressure of pure water supply device 7; and pressure sensor 51 that detects the discharge pressure of cooling water supply device 37. Controller 14 controls the motor that drives pure water supply device 7 and the motor that drives cooling water supply device 37 based on the values detected by pressure sensor 16, pressure sensor 50, and pressure sensor 51.

Next is provided an explanation of the operation of the fuel cell system that pertains to Embodiment 1.

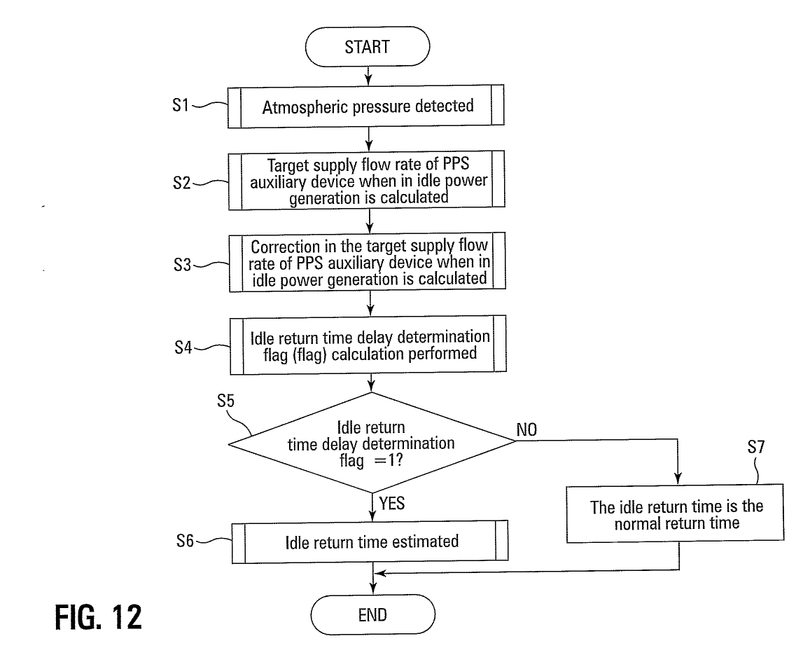

Main Flowchart (FIG. 12)

First, an explanation is provided of the entire operation with reference to the flowchart in FIG. 12. The control method of the fuel cell system estimates the idle return time of the PP system from the atmospheric pressure detected by pressure sensor 16. The main process content of FIG. 12 is executed at predetermined time increments (for instance, every 10 ms) from the time of initiating operation of the fuel cell.

At Step S1, pressure sensor 16 detects the atmospheric pressure, at Step S2, the target flow rate of the fluid (oxidant) supplied while the auxiliary device (oxidant gas supply device 3) of the PP system is in idle operation is calculated, and at Step 3, the target supply flow rate is corrected based on the target supply flow rate of oxidant gas supply device 3 when in idle operation calculated at Step S2 and the atmospheric pressure detected at S1. At Step S4, the determination flag (flag=flag A or Flag B or flag C) that indicates whether or not the idle return time is delayed based on the target supply flow rate corrected at Step S3 is calculated. At Step S5, it is determined whether the determination flag calculated at Step S4 is 1 or not. If the determination flag is 1 (YES at S5), then the process proceeds to Step S6 where it ends by estimating the idle return time. Further, if the determination flag is 0 (NO at S5), then the process proceeds to Step S7 where it ends by selecting a standard (1 atmosphere at normal temperature) idle return time as the idle return time.

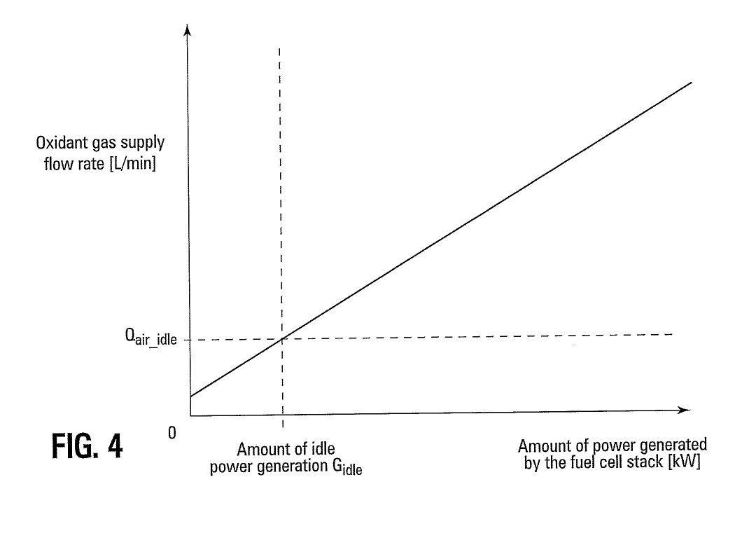

Next, an explanation is provided of the process for calculating the target supply flow rate of the auxiliary device when in idle operation for Step S2, using FIG. 4. For example, when in standard atmospheric condition (1013.25 hPa, 15° C.), the supply flow rate of the oxidant gas that needs to be supplied in order to execute a predetermined power generation by fuel cell stack 19 is derived by previous experiments, and as shown in FIG. 4, and the relationship between the supply flow rate of the oxidant gas and the power generation level of fuel cell stack 19 can be derived.

When the vehicle is in a predetermined idle state (a vehicle speed of 0 km/h with no requirement to charge the battery), the idle power generation level required for power generation by fuel cell stack 19 is G_{idle}[kW] shown in FIG. 4; and the target supply flow rate of the oxidant gas while in idle operation that is supplied to fuel stack 19 in order to realize the idle power generation level becomes Qₐᵢᵣ_{_{—}}_{idle}[NL/min].

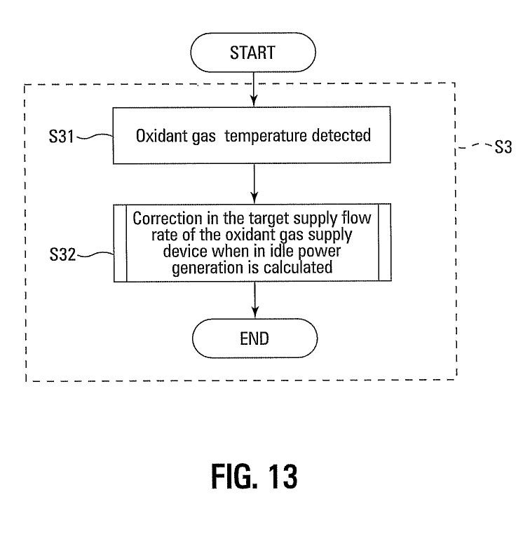

The Flowchart for Calculating the Correction in the Target Supply Flow Rate of the Oxidant Gas when in Idle Operation (FIG. 13)

Next is provided an explanation of the method used to correct the target supply flow rate of oxidant gas supply device 3 in Step S3, using the flowchart in FIG. 13.

At Step S31, temperature sensor 17 detects the temperature of the oxidant gas taken in by oxidant gas supply device 3, at Step S32, the corrected value of the target supply flow rate is calculated based on the target supply flow rate of oxidant gas supply device 3 when in idle operation that was calculated at Step S2 and the atmospheric pressure detected at Step S1 of FIG. 12.

Next an explanation is provided for the method used to calculate the corrected value of Step S32. For example, a description is provided for calculating when the target supply flow rate calculated at Step S2 is a normal volume flow rate [NL/min].

When the target supply flow rate of the oxidant gas calculated at Step S2 is Qₐᵢᵣ_{_{—}}_{idle}[NL/min], the atmospheric pressure detected at Step S1 is Pᵢₙ _{_{—}}ₐᵢᵣ[kPa], and the temperature of the oxidant gas detected at Step S31 is Tᵢₙ_{_{—}}ₐᵢᵣ[degC], the target supply flow rate Qₐᵢᵣ_{_{—}}_{idle}′[L/min] after the correction has been made can be calculated according to Formula (1).

$${Q}_{air\_idle}^{′} = {Q}_{air\_idle} \times \frac{101.325}{{P}_{in\_air}} \times \frac{( {T}_{in\_air} + 273.15 )}{273.15} L \text{/} min \qquad ( 1 )$$

When calculating the target supply flow rate calculated at step S2 to be mass flow rate Qₐᵢᵣ_{_{—}}_{idle}[g/min], the oxidant gas density according to Formula (2) given below can be calculated, and the target supply flow rate Qₐᵢᵣ_{_{—}}_{idle}′[L/min] after the correction to the oxidant gas has been made can also be calculated according to Formula (3).

The oxidant gas density at a gaseous standard state (0° C. and 101.325 kPa) is [g/L]; therefore, the oxidant gas density [g/L] can be calculated according to Formula (2)

[Formula 2]

σ=(1.293/(1+0.00367×T_{CMP}_{_{—}}_{IN1}))×P₁/101.325[g/L] (2)

[Formula 3]

Qₐᵢᵣ_{_{—}}_{idle}′=Qₐᵢᵣ_{_{—}}_{idle}/σ (3)

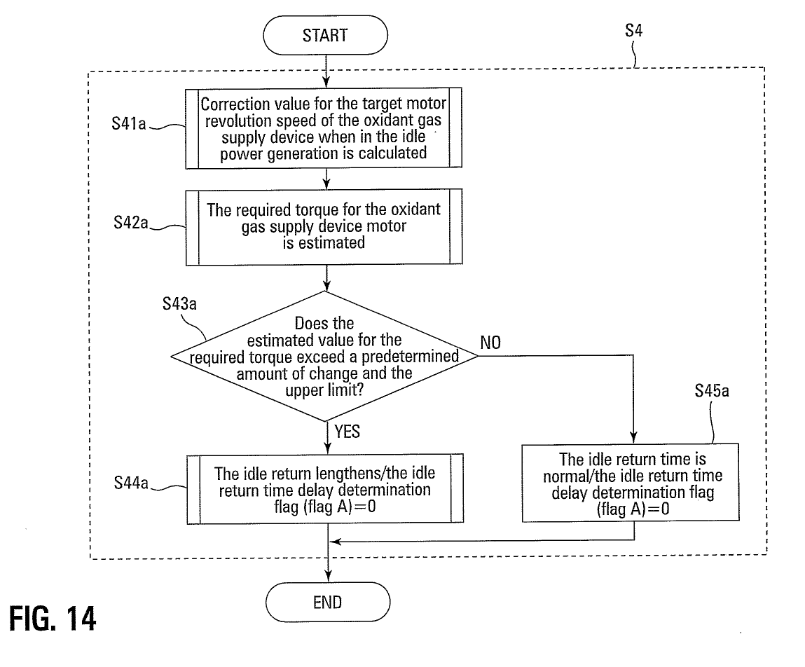

The Calculation and Control Flowchart for the Motor Revolution Speed of the Oxidant Gas Supply Device when in Idle Operation (FIG. 14)

Next is provided an explanation of the method used to calculate the determination flags that indicate whether the idle return time of Step S4 is delayed or not, using the flowchart in FIG. 14.

At Step S41, the motor revolution speed of oxidant gas supply device 3 required to realize the target supply flow rate for after the correction has been made is calculated from the target supply flow rate for after the correction has been made that was calculated in step S32 of FIG. 13. At Step S42a, the torque and the amount of change thereof required for output by the motor of oxidant gas supply device 3 when increasing the motor revolution speed from a motor revolution speed of 0 rpm to the motor revolution speed calculated at step S41 within the idle return time is estimated. At Step S43a, it is determined whether the torque and the amount of change thereof estimated in Step S42a, respectively, exceeds the upper limit of torque and the upper limit of the amount of change in torque based on the individual properties of the motor of oxidant gas supply device 3. If it exceeds, (YES at step S43a), then the process proceeds to Step S44a, where if the torque estimated at S43a is determined to have exceeded the upper limit of torque and the upper limit of the amount of change in torque based on the individual properties of the motor, then the idle return time delay determination flag (flag A) is set to 1 and the process is ended. Further, if it has not exceeded (NO at step S43a), then the process proceeds to Step S45a, where if the torque estimated at Step S43a is determined to have not exceeded the upper limit of torque and the upper limit of the amount of change in torque based on the individual properties of the motor, then the determination flag (flag A) is set to 0 and the process is ended.

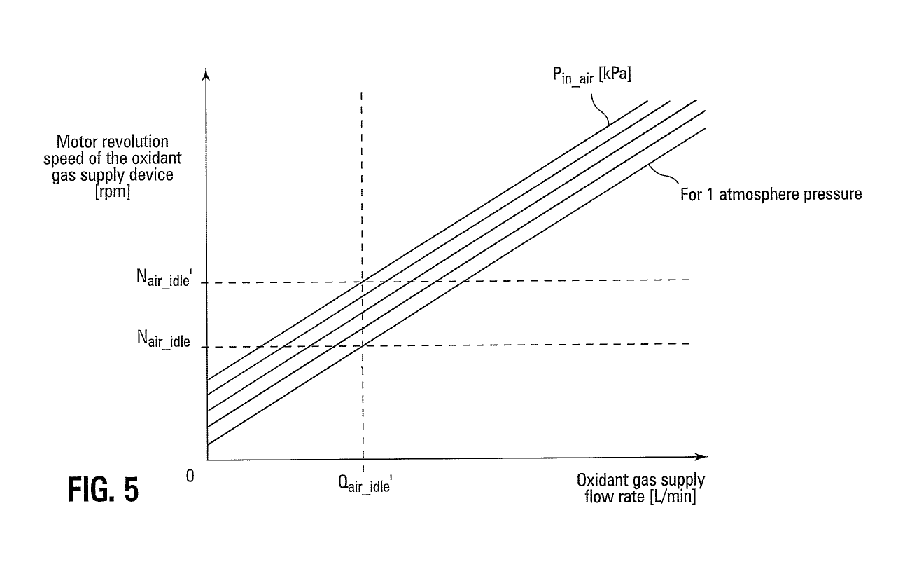

Next is provided an explanation of the method used to calculate the motor revolution speed of oxidant gas supply device 3 in Step S41a, using FIG. 5.

The relationship between the motor revolution speed of oxidant gas supply device 3 and the flow rate of the oxidant gas supplied to fuel cell stack 19 is derived by previous experiments with the atmospheric pressure being the parameter. Here, even if the supply amount of oxidant gas remains the same while the atmospheric pressure falls, the motor revolution speed of oxidant gas supply device 3 increases by such relationship. From this relationship, the motor revolution speed Nₐᵢᵣ_{_{—}}_{idle}[rpm] of the oxidant gas supply device when supplying the target supply flow rate Qₐᵢᵣ_{_{—}}_{idle}[NL/min] of the oxidant gas when in idle operation, and the target motor revolution speed Nₐᵢᵣ_{_{—}}_{idle}′[rpm] when supplying the target supply flow rate Qₐᵢᵣ_{_{—}}_{idle}′[L/min] for after the correction has been made, can be calculated.

As described above, the correction amount ΔNₐᵢᵣ_{_{—}}_{idle}[rpm] of the target revolution speed of the oxidant gas supply device motor when in idle operation can be calculated according to Formula (4).

[Formula 4]

ΔNₐᵢᵣ_{_{—}}_{idle}=Nₐᵢᵣ_{_{—}}_{idle}′−Nₐᵢᵣ_{_{—}}_{idle}[rpm] (4)

Next is provided an explanation of the method used to estimate the torque required by the motor of oxidant gas supply device 3 in Step S42a.

The torque required by the motor when outputting target motor revolution speed Nₐᵢᵣ_{_{—}}_{idle}′[rpm], for a normal idle return time of tₐᵢᵣ_{_{—}}_{idle}[sec], after the correction has been made when in idle operation, is made to be Trₐᵢᵣ_{_{—}}_{idle}′[Nm], the load applied to the motor for oxidant gas supply device 3 is RLₐᵢᵣ[Nm], and the inertia of the motor for oxidant gas supply device 3 is Iₐᵢᵣ[kg·m̂2]. Further, motor load RLₐᵢᵣ[Nm] of oxidant gas supply device 3 is a function of the pressure ratio Prₐᵢᵣ[−] of oxidant gas supply device 3 and the motor revolution speed Nₐᵢᵣ[rpm], and can be expressed as shown in Formula (5).

[Formula 5]

RLₐᵢᵣ=RLₐᵢᵣ(Nₐᵢᵣ,Prₐᵢᵣ) (5)

When the target motor revolution speed Nₐᵢᵣ_{_{—}}_{idle}′[rpm] for after the correction has been made in oxidant gas supply device 3 when in idle operation is converted to motor angle speed ωₐᵢᵣ_{_{—}}_{idle}′[rad/sec], it is expressed as shown in Formula (6).

[Formula 6]

ωₐᵢᵣ_{_{—}}_{idle}′=Nₐᵢᵣ_{_{—}}_{idle}′×(2×π)/60 (6)

In addition, the motor angle speed ωₐᵢᵣ_{_{—}}_{idle}′[rad/sec] can be expressed as shown Formula (7).

[Formula 7]

ωₐᵢᵣ_{_{—}}_{idle}′=∫₀^{air}^{_{—}}^{idle}(Trₐᵢᵣ_{_{—}}_{idle}′−RLₐᵢᵣ)/Iₐᵢᵣ·dt (7)

Formula (6) combined with Formula (7) becomes Formula (8).

[Formula 8]

Nₐᵢᵣ_{_{—}}_{idle}′×(2×π)/60=∫₀^{air} ^{_{—}}^{idle}(Trₐᵢᵣ_{_{—}}_{idle}′−RLₐᵢᵣ)/Iₐᵢᵣ·dt (8)

In addition, when expanding the right side of Formula (8) to make Trₐᵢᵣ_{_{—}}_{idle}′=kt, it is expressed as shown in Formulae (9-1) and (9-2).

$$\begin{matrix}[ Formula 9 ] & \\ {N}_{air\_idle}^{′} \times ( 2 \times π ) / 60 = {[ \frac{{kt}^{2}}{2} \times \frac{1}{{I}_{air}} ]}_{0}^{{t}_{air\_idle}} - {\int }_{0}^{{t}_{air , idle}} {RL}_{air} / {I}_{air} \cdot d t & ( 9 \text{-} 1 ) \\ k = ( {N}_{air\_idle}^{′} \times ( 2 \times π ) / 60 + {\int }_{0}^{{t}_{air\_idle}} {RL}_{air} / {I}_{air} \cdot d t ) \times 2 \times {I}_{air} / {t}_{air\_idle}^{2} & ( 9 \text{-} 2 )\end{matrix}$$

Therefore, since the torque required by the oxidant gas supply device motor Trₐᵢᵣ_{_{—}}_{idle}′[Nm/sec] when outputting corrected value Nₐᵢᵣ_{_{—}}_{idle}′[rpm] for the target revolution speed of the oxidant supply device motor when in idle operation is “k” in Formula (9-2), the amount of change in the required torque ΔTrₐᵢᵣ_{_{—}}_{idle}′[Nm/sec] when outputting the required torque when in normal idle return time tₐᵢᵣ_{_{—}}_{idle}[sec], is as shown in Formula (10).

[Formula 10]

ΔTrₐᵢᵣ_{_{—}}_{idle}′=(Nₐᵢᵣ_{_{—}}_{idle}′×(2×π)/60+∫₀^{air} ^{_{—}}^{idle}RLₐᵢᵣ/Iₐᵢᵣ·dt)×2×Iₐᵢᵣ/tₐᵢᵣ_{_{—}}_{idle}² (10)

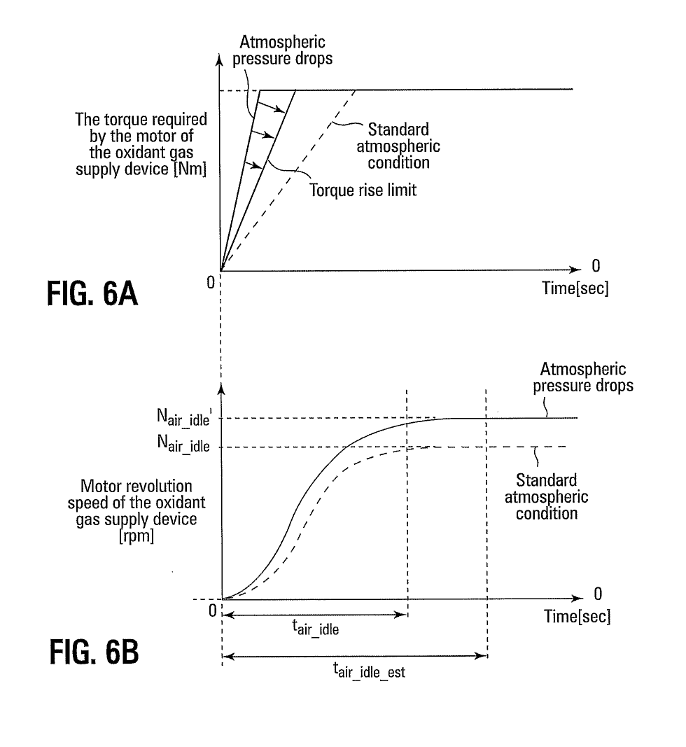

Finally, an explanation is provided using FIG. 6 (a) and FIG. 6 (b) of the method used to estimate the idle return time at Step S6 of FIG. 12.

The torque required when attempting to reach the predetermined motor revolution speed within the normal idle return time when there is a sudden drop in the atmospheric pressure rises rapidly according to the change ratio shown in FIG. 6 (a) to exceed the torque rise limit. Therefore, the time it takes to arrive at the predetermined motor revolution speed is delayed beyond the normal idle return time, as shown in FIG. 6 (b). Conversely, the torque rise under standard atmospheric conditions is lower than the torque rise limit, thereby allowing it to reach the predetermined motor revolution speed within the normal idle return time.

When the upper limit of the torque based on the individual characteristics of the motor of oxidant gas supply device 3 is made to be Trₐᵢᵣ_{_{—}}ᵤₚₚₑᵣ[Nm], and the upper limit in the amount of change in torque to be ΔTrₐᵢᵣ_{_{—}}ᵤₚₚₑᵣ[Nm/sec], then the estimated value tₐᵢᵣ_{_{—}}_{idle}_{_{—}}ₑₛₜ[sec] for the idle return time can be calculated according to Formula (11). However, ΔTrₐᵢᵣ_{_{—}}ᵤₚₚₑᵣ<ΔTrₐᵢᵣ_{_{—}}_{idle}′.

[Formula 11]

tₐᵢᵣ_{_{—}}_{idle}_{_{—}}ₑₛₜ=Trₐᵢᵣ_{_{—}}_{idle}′/ΔTrₐᵢᵣ_{_{—}}ᵤₚₚₑᵣ (11)

As explained above, the fuel cell system that pertains to Embodiment 1 comprises: fuel cell (fuel cell stack) 19 that generates power by supplying a fuel gas (hydrogen gas) that contains hydrogen, and an oxidant gas that contains oxygen; idle stopping means (PP system auxiliary device control means) 53 that stops power generation of fuel cell stack 19 that is in idle operation and puts it in an idle stopped state; atmospheric pressure detection means (atmospheric pressure sensor) 16 that detects the atmospheric pressure of the periphery of fuel cell stack 19; and idle return time estimation means 63 that estimates the idle return time from the time at which fuel cell stack 19 that is in the idle stopped state starts the start-up operation until it returns to idle operation based on the atmospheric pressure detected by atmospheric pressure sensor 16. As a result, a very accurate return time can be achieved.

The fuel cell system further comprises: fluid supply device (oxidant gas supply device) 3 that supplies the fluid (oxidant gas) to fuel cell stack 19 due to the rotation of the motor; a flow rate calculation means that calculates the flow rate of the oxidant gas that is required to realize idle operation; and a motor revolution speed calculation means that calculates the revolution speed of the motor for the oxidant gas supply device that is required to realize the flow rate calculated by the flow rate calculation means. In addition, idle return time estimation means 63 corrects the motor revolution speed calculated by the motor revolution speed calculation means based on the atmospheric pressure and estimates the idle return time based on the motor revolution speed for after the correction has been made. As a result, a very accurate idle return time can be achieved.

Embodiment 1 uses oxidant gas supply device 3 as an example of the “fluid supply device” to supply oxidant gas to the fuel cell stack. In this case, the flow rate calculation means is the oxidant gas flow rate calculation means that calculates the flow rate of the oxidant gas required to realize idle operation, and the motor revolution speed calculation means calculates the revolution speed of the motor for the oxidant gas supply device required to realize the flow rate of the oxidant gas calculated by the oxidant gas flow rate calculation means. As a result, a very accurate return time can be achieved.

The fuel cell system comprises temperature sensor 17 to measure the atmospheric temperature as an example of the oxidant gas temperature detection means that detects the temperature of the oxidant gas that is taken in by oxidant gas supply device 3. In this case, controller 14 functions as the motor revolution speed calculation means that corrects the motor revolution speed in accordance with the density estimated by the oxidant gas density estimation means and the oxidant gas density estimation means that estimates the density of the oxidant gas taken in by oxidant gas supply device 3 based on the atmospheric pressure and the temperature detected by temperature sensor 17. As a result, a very accurate idle return time can be achieved.

The fuel cell system further comprises an oxidant gas pressure detection means that detects the pressure of the oxidant gas discharged by oxidant gas supply device 3. In this case, idle return time estimation means 63 calculates the pressure ratio between the atmospheric pressure and the pressure detected by the oxidant gas pressure detection means, corrects the motor revolution speed in accordance with said pressure ratio and estimates the idle return time based on the motor revolution speed for after the correction has been made.

For Embodiment 1 of the present invention, a fuel cell system is installed in a vehicle with a fuel cell as its main power source. When the state of the vehicle is determined to be in a predetermined idle state, oxidant gas supply device 3 is stopped, the power generation of fuel cell stack 19 is stopped, and the vehicle is put it into an “idle stopped state.” In addition, when the state of the vehicle is determined to be in a non-idle state, or when the residual capacity of the capacitor or battery drops below a predetermined value, oxidant gas supply device 3 is driven to restart fuel cell stack 19.

Conventionally, idle stopping posed problems such as 1) the idle stop method, and 2) differing response times until restart according to the idle stop state. Various controls (energy management control, drive motor control) performed by the fuel cell vehicle have been problematic in that variations occur in the standard output response times, causing significant affect to be exerted on these controls because they are performed based on basic standard output response times.

Therefore, Embodiment 1 of the present invention estimates the cause of the response time variations at the time of restart from the idle stopped state (idle stop), and estimates the standard output response time (idle return time) of fuel cell stack 19 accordingly. Energy management control and drive motor control can be more precisely performed by a more precise estimation of the standard output response time.

When initiating an auxiliary device comprising a system in order to stop only the power generation of fuel cell stack 19, a delayed P/M response may also cause a delay in the idle return time.

### Embodiment 2

As was the case with Embodiment 1, Embodiment 2 also uses oxidant gas supply device 3 to supply oxidant gas to the fuel cell stack as an example of the “fluid supply device (PP System auxiliary device)”.

The explanations pertaining to FIG. 1 through FIG. 6 and FIG. 12 through FIG. 14 are the same as those for Embodiment 1 and have therefore been omitted.

The summary of the operation is the same as that for Embodiment 1.

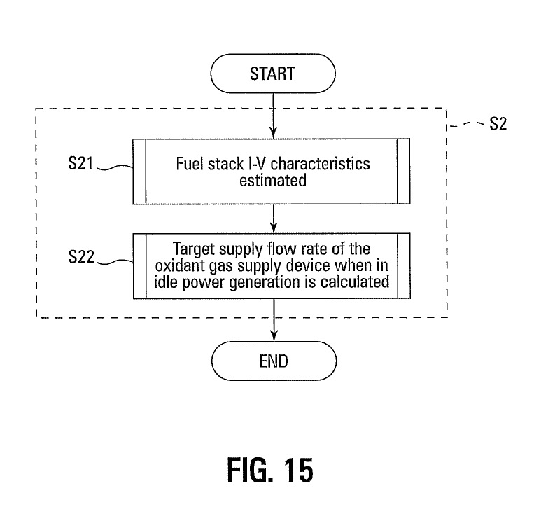

The Flowchart for Calculating the Target Supply Flow Rate of the Oxidant Gas Supply Device when in Idle Operation (FIG. 15)

An explanation using the flowchart in FIG. 15 is provided of the method used to calculate the target supply flow rate of oxidant gas supply device 3 when in idle operation at Step S2 in FIG. 12.

At Step S21, the current/voltage characteristics (I-V characteristics) of fuel cell stack 19 are estimated; and at Step S22, the target supply flow rate of the oxidant gas is calculated based on the I-V characteristics of fuel cell stack 19 estimated in Step S21 and the process is ended.

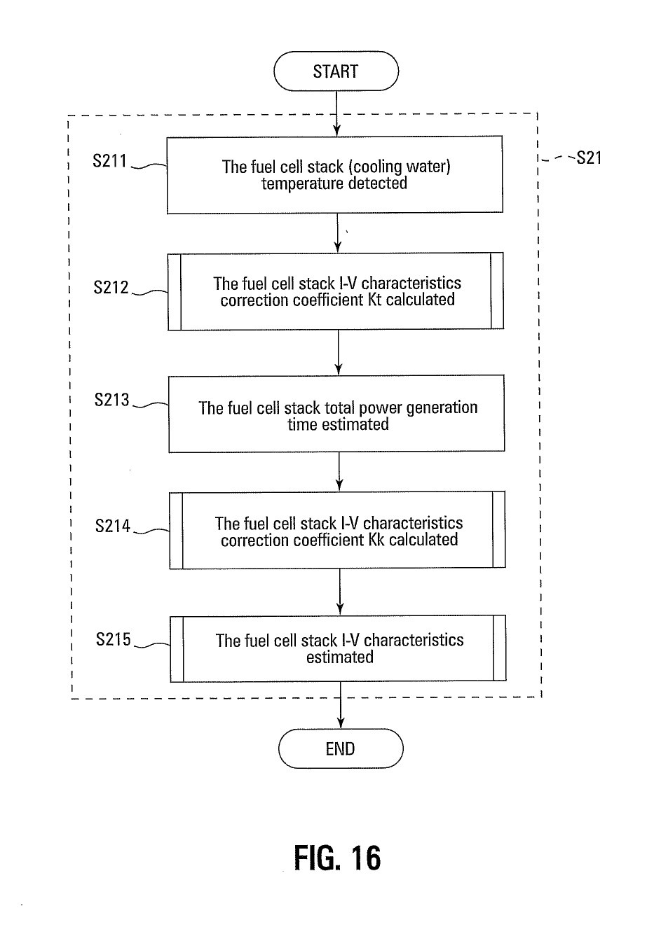

The Flowchart for Estimating the I-V Characteristics of the Fuel Cell Stack (FIG. 16)

An explanation using the flowchart in FIG. 16 is provided of the method used to estimate the I-V characteristics of fuel stack 19 in Step S21.

At Step S211, the temperature of fuel cell stack 19 or the temperature of the cooling water for cooling fuel cell stack 19 that is nearly the same value as the temperature of fuel cell stack 19 is detected. At Step S212, the correction coefficient kₜ[−] of the I-V characteristics of fuel cell stack 19 is calculated based on the temperature of fuel cell stack 19 detected in step S211. At Step S213, the total power generation time of fuel cell stack 19 is estimated; and at Step S214, the correction coefficient kₖ[−] of the I-V characteristics of fuel cell stack 19 is calculated based on the estimated value of the total power generation time of fuel cell stack 19 estimated in Step S213. At Step S215, the I-V characteristics of fuel cell stack 19 are calculated from the correction coefficient kₜ[−] of the I-V characteristics calculated in Step S212, the correction coefficient kₖ[−] of the I-V characteristics calculated in Step S214 and the ideal I-V characteristics of fuel cell stack 19, and the process is ended.

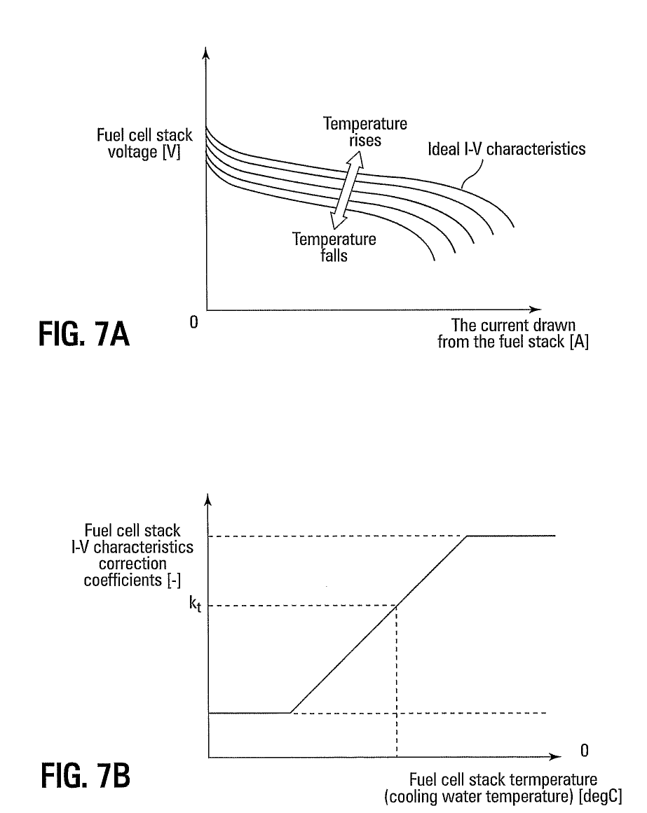

Next, an explanation using FIG. 7 (a) and FIG. 7(b) is provided of the method used to calculate the correction coefficient kₜ[−] based on the temperature (cooling water temperature) of fuel cell stack 19 in Step S212.

The relationship between the independent temperature of fuel cell stack 19, or the temperature of the cooling water of fuel cell stack 19, and the I-V characteristics of fuel cell stack 19 is derived by previous experiments as shown in FIG. 7 (a). Further, the correction coefficient kₜ[−] is derived from this relationship as shown in FIG. 7 (b) for ideal I-V characteristics of fuel cell stack 19.

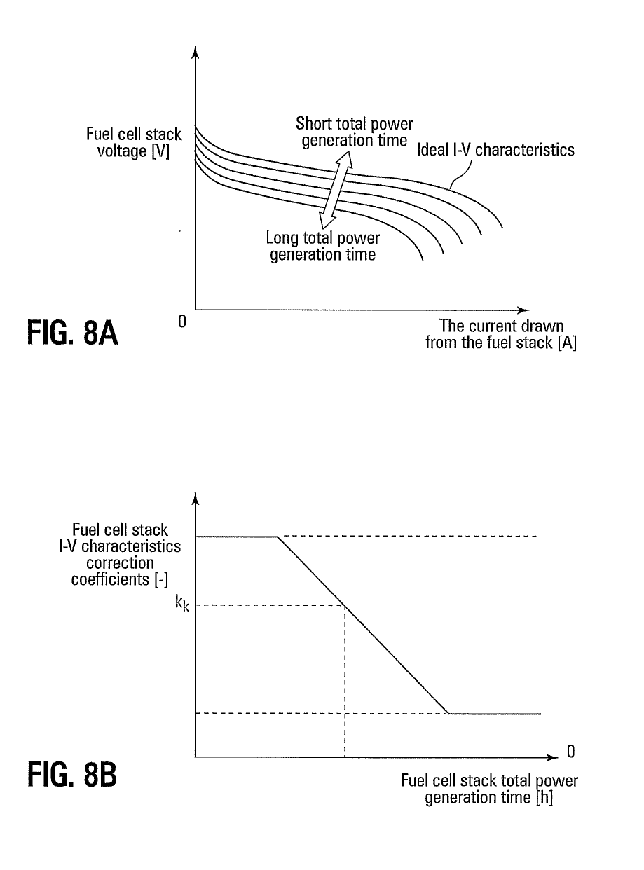

Next, an explanation using FIG. 8 (a) and FIG. 8 (b) is provided of the method used to calculate the correction coefficient kₖ[−] based on the total power generation time of fuel cell stack 19 in Step S214.

The relationship between the total power generation time of fuel cell stack 19 and the I-V characteristics of fuel cell stack 19 is derived by previous experiments as shown in FIG. 8 (a). Further, the correction coefficient kₖ[−] is derived from this relationship as shown in FIG. 8 (b) for ideal I-V characteristics of fuel cell stack 19.

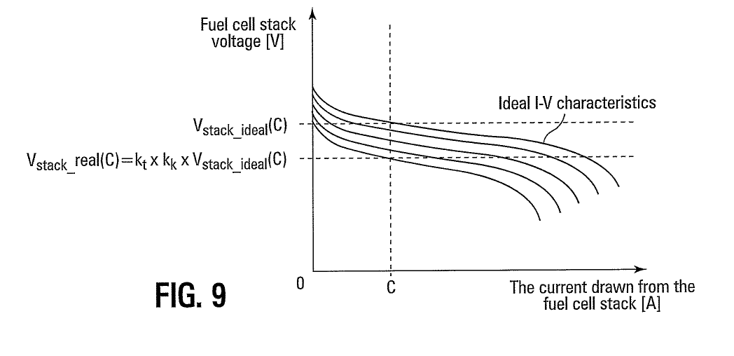

In addition, an explanation using FIG. 9 is provided of the method used to estimate the I-V characteristics of fuel cell stack 19 in Step S215.

Regarding the ideal I-V characteristics of fuel cell stack 19, the I-V characteristics V_{stack}_{_{—}}ᵣₑₐₗ(C) of fuel cell stack 19 are estimated, according to Formula (12), from the correction coefficient kₜ[−] based on the temperature (cooling water temperature) of fuel cell stack 19 calculated in Step S212, the correction coefficient kₖ[−] based on the total power generation time of fuel cell stack 19 calculated in Step S214, and the stack voltage V_{stack}_{_{—}}_{ideal}(C) when drawing the prescribed current C[A] under the ideal I-V characteristics of the fuel cell stack 19.

[Formula 12]

V_{stack}_{_{—}}ᵣₑₐₗ(C)=kₜ×kₖ×V_{stack}_{_{—}}_{ideal}(C) (12)

In addition to the method used to estimate the I-V characteristics provided above, another method for calculating the I-V characteristics of a fuel cell stack would be to learn the I-V characteristics during the start-up of fuel cell stack 19.

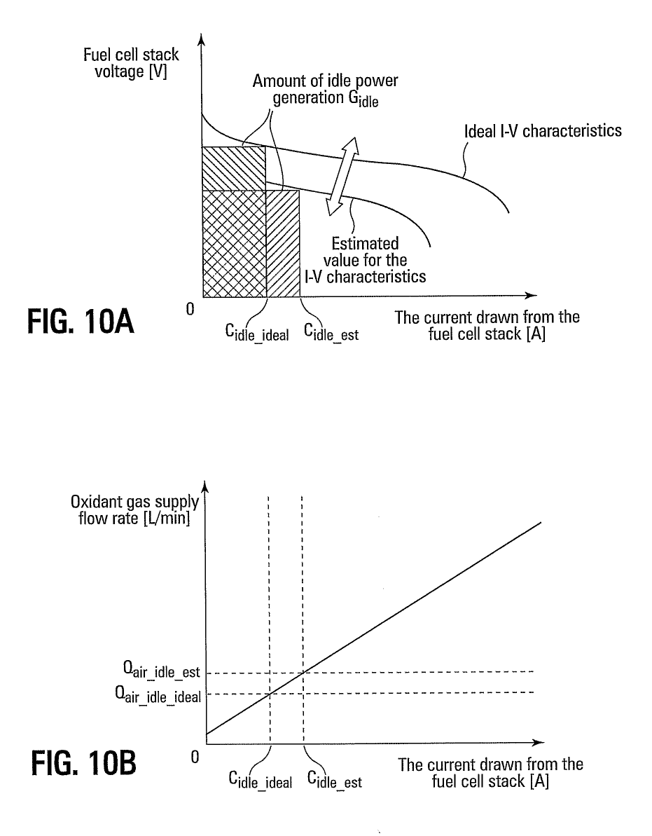

Next, an explanation using FIG. 10 (a) and FIG. 10 (b) is provided of the method used to calculate the target supply flow rate of oxidant gas supply device 3 in Step S22.

The relationship between the ideal I-V characteristics of fuel cell stack 19 and the estimated values of the I-V characteristics calculated according to Formula 12 is shown in FIG. 10 (a). Further, the current drawn from fuel cell stack 19 when generating idle power generation amount G_{idle}[kW] for each I-V characteristic is C_{idle}_{_{—}}ₑₛₜ[A] when estimating the I-V characteristics and C_{idle}_{_{—}}_{ideal}[A] for the ideal I-V characteristics. Furthermore, the target supply flow rate of the oxidant gas when in idle operation is Qₐᵢᵣ_{_{—}}_{idle}_{_{—}}ₑₛₜ[A] when estimating I-V characteristics and Qₐᵢᵣ_{_{—}}_{idle}_{_{—}}_{ideal}[A] for the ideal I-V characteristics.

Finally, the target supply flow rate Qₐᵢᵣ_{_{—}}_{idle}[NL/min] for the oxidant gas supplied to fuel cell stack 19 in order to realize an idle power generation amount of G_{idle}[kW] is shown in Formula (13).

[Formula 13]

Qₐᵢᵣ_{_{—}}_{idle}=Qₐᵢᵣ_{_{—}}_{idle}_{_{—}}ₑₛₜ (13)

The same method that was used in Embodiment 1 can be used for other arithmetic calculations of the estimated value for the idle return time tₐᵢᵣ_{_{—}}_{idle}_{_{—}}ₑₛₜ[sec].

As explained above, for the fuel cell system pertaining to Embodiment 2, controller 14 further provides a function whereby a current/voltage characteristics estimation means estimates the I-V characteristics of fuel cell stack 19. Then, controller 14 uses idle return time estimation means 63 to further correct the motor revolution speed in accordance with the I-V characteristics estimated by the current/voltage characteristics estimation means and then estimates the idle return time based on the motor revolution speed for after the correction has been made. Therefore, the motor revolution speed is not only corrected based on the density of the fluid, but is further corrected based on the I-V characteristics, resulting in the ability to achieve a very accurate idle return time.

The current/voltage characteristics estimation means estimates the I-V characteristics based on the temperature pertaining to fuel cell stack 19. However, the concept of “the temperature pertaining to fuel cell stack 19” includes the independent temperature of the single cell, cell stack or cell module that constitute the fuel cell stack and the temperature of the cooling water that cools the cell stack. In this manner, the current/voltage characteristics of fuel cell stack 19 can be estimated in accordance with the temperature pertaining to fuel cell stack 19.

The current/voltage characteristics estimation means estimates the I-V characteristics from the total power generation time of fuel cell stack 19. The “total power generation time” represents the total amount of time in which power was generated by fuel cell stack 19, including the time in which it transmitted power outside of the fuel cell and the time in which it generated power to a local load. In this manner, the current/voltage characteristics of fuel cell stack 19 can be estimated in accordance with the deteriorating state of fuel cell stack 19.

The I-V characteristics are estimated from the relationship between the current and voltage drawn from fuel cell stack 19. And, since the current/voltage characteristics of fuel cell stack 19 are estimated by learning the relationship between the current and total voltage drawn from fuel cell stack 19 while the fuel cell system is in operation, the current/voltage characteristics of fuel cell stack 19 can be estimated based on the state of fuel cell stack 19

### Embodiment 3

As was the case with Embodiment 1, Embodiment 3 also uses oxidant gas supply device 3 to supply oxidant gas to fuel cell stack 19 as an example of a “fluid supply device (PP system auxiliary device)”.

The explanations pertaining to FIG. 1 through FIG. 10 and FIG. 12 through FIG. 16 are the same as those for Embodiment 1 and 2 and have therefore been omitted.

The summary of the operation is the same as that for Embodiment 1.

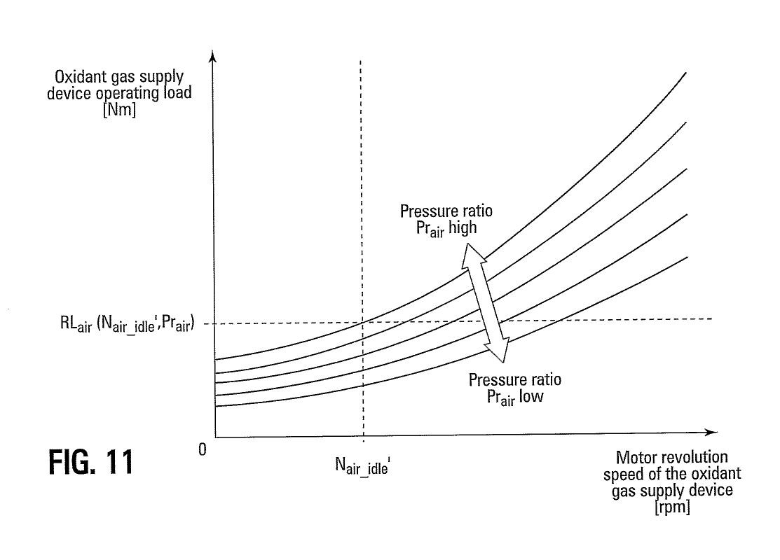

Next is provided an explanation of the method used to estimate the torque required by oxidant gas supply device 3 in Step S42a of FIG. 14, using FIG. 11.

The pressure Pₐᵢᵣ_{_{—}}_{stack}_{_{—}}ᵢₙ[kPa) of the oxidant gas at the opening of the cathode of fuel cell stack 19 is detected by oxidant gas pressure sensor 10 and the pressure ratio Prₐᵢᵣ[−] of oxidant gas supply device 3 explained in Embodiment 1 is calculated as the following formula (14) from the atmospheric pressure Pᵢₙ_{_{—}}ₐᵢᵣ[kPa] detected at Step S1 of FIG. 12.

[Formula 14]

Prₐᵢᵣ=Pₐᵢᵣ_{_{—}}_{stack}_{_{—}}ᵢₙ/Pᵢₙ_{_{—}}ₐᵢᵣ (14)

In addition, Formula (5) representing motor load RLₐᵢᵣ[Nm] of oxidant gas supply device 3, which was described in Embodiment 1, is derived by previous experiments based on the relationship between the motor revolution speed Nₐᵢᵣ[rpm] of oxidant gas supply device 3 and the pressure ratio Prₐᵢᵣ[−] of oxidant gas supply device 3 and motor load RLₐᵢᵣ[Nm] of oxidant gas supply device 3 is calculated from the target motor revolution speed Nₐᵢᵣ_{_{—}}_{idle}′[rpm] after oxidant gas supply device 3 has been corrected when in idle operation as calculated at Step S41a in FIG. 14 and Formula (14).

The same calculation method that was used in Embodiments 1 and 2 is also used to calculate the estimated value for the idle return time, tₐᵢᵣ_{_{—}}_{idle}_{_{—}}ₑₛₜ[sec].

### Embodiment 4

Embodiment 4 uses pure water supply device 7 to supply pure water for humidifying the oxidant gas supplied to fuel cell stack 19 as another example of a “fluid supply device (PP system auxiliary device)”.

The explanations pertaining to FIG. 1 through FIG. 3 and FIG. 12 are the same as those for Embodiment 1 and have therefore been omitted.

The summary of the operation is the same as that for Embodiment 1. For Embodiment 4 of the present invention, a fuel cell system is installed in a vehicle with fuel cell stack 19 as the main power source. When the state of the vehicle is determined to be in a predetermined idle state, the idle stopping means stops pure water supply device 7, stops power generation of fuel cell stack 19, and puts it in “idle stopped state”.

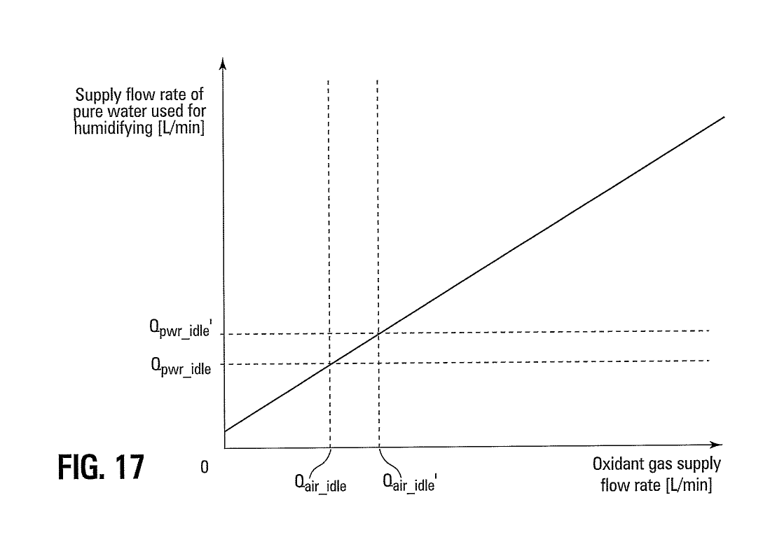

Next, is provided an explanation of the method used to calculate the target supply flow rate of pure water supply device 7 at Step S2 in FIG. 12, using FIG. 17. As shown in FIG. 17, the relationship between the flow rate of the oxidant gas supplied to fuel cell stack 19 and the flow rate of the pure water that is used to humidify the oxidant gas is derived by previous experiments. The target supply flow rate of the pure water used to humidify the target supply flow rate Qₐᵢᵣ_{_{—}}_{idle}[L/min] of the oxidant gas when in idle operation, as explained in Embodiment 1, becomes Q_{pwr}_{_{—}}_{idle}[L/min].

Next, using FIG. 17, an explanation is provided of one example of the method used to correct the target supply flow rate of pure water supply device 7 at Step S3 in FIG. 12. The relationship between the flow rate of the oxidant gas supplied to fuel cell stack 19 and the flow rate of the pure water that is used to humidify the oxidant gas is derived by previous experiments. The target supply flow rate Qₐᵢᵣ_{_{—}}_{idle}′[L/min] after the correction has been made in the oxidant gas when in idle operation, as explained in Embodiment 1, becomes Q_{pwr}_{_{—}}_{idle}′[L/min].

In addition to the method explained here for calculating the target flow rate for after the correction has been made in pure water supply device 7 when in idle operation, another method, for instance, would be to estimate the partial water vapor pressure of the intake oxidant gas from the temperature of the oxidant gas taken in by oxidant gas supply device 3, which is detected by temperature sensor 17, and then correct the target supply flow rate of pure water supply device 7 when in idle operation, based on this estimated value for the partial water vapor pressure.

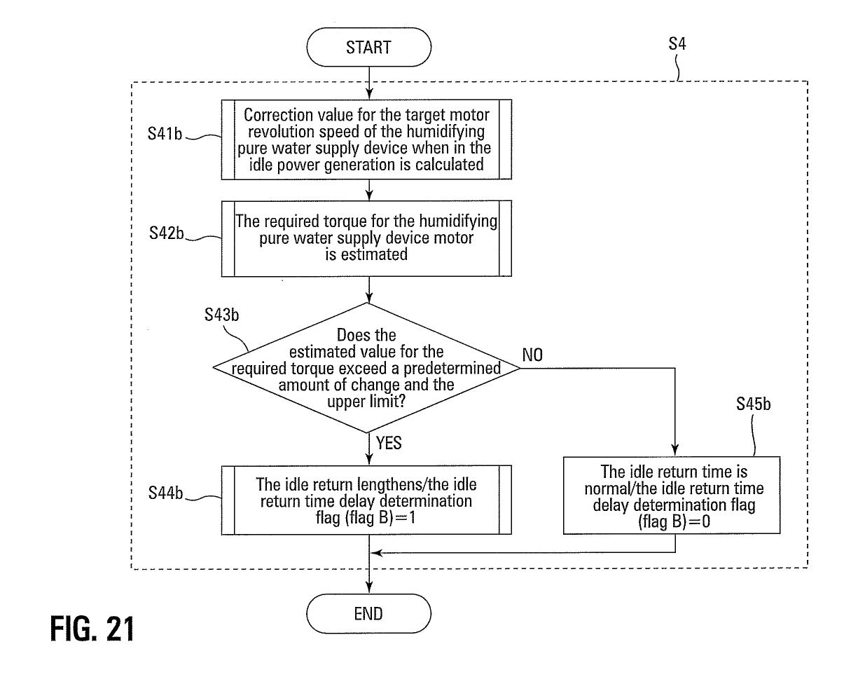

Calculation-Control Flow Chart for the Motor Revolution Speed of the Pure Water Supply Device Used for Humidifying when in Idle Operation (FIG. 21)

Next is provided an explanation of the method used to calculate the delay determination flag for the idle return time in Step S4 of FIG. 12, using the flowchart shown in FIG. 21.

At Step S41b, the motor revolution speed of pure water supply device 7 for realizing the target supply flow rate after the correction has been made is calculated from the target supply flow rate for when after the correction has been made in pure water supply device 7 when in idle operation that was calculated at Step S3. At Step S42b, the amount of torque required for the output of the motor of pure water supply device 7 for when the motor is rotated at the normal idle return time is estimated from a motor revolution speed of 0 rpm up until the motor revolution speed calculated at Step S41b. At Step S43b, it is determined whether or not the estimated torque value of pure water supply device 7 estimated at Step S42b exceeds the upper limit of torque and the upper limit of the amount of change in torque based on the individual properties of the motor of pure water supply device 7. At Step S43b, if the estimated value of the torque is determined to be more than the upper limit of torque and the upper limit of the amount of change in torque based on the individual properties of the motor (YES at Step S43b), the process proceeds to Step S44b, a delay is determined in the idle return time, the idle return time delay determination flag (flag B) is set to “1”, and the process is ended. On the other hand, at Step S43b, if the estimated value of the torque is determined to not be more than the upper limit of torque and the upper limit of the amount of change in torque based on the individual properties of the motor (NO at Step S43b), the process proceeds to Step S45b, no delay is determined in the idle return time, the idle return time delay determination flag (flag B) is set to “0”, and the process is ended.

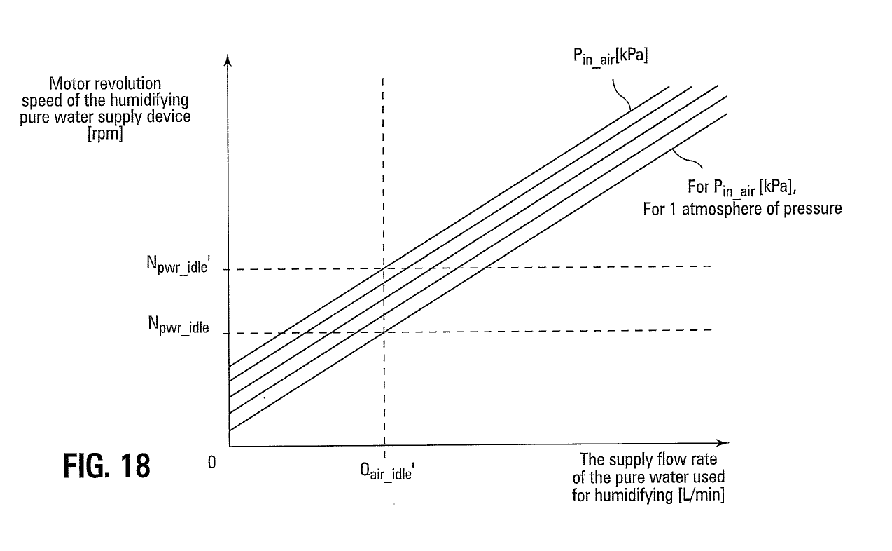

Next, is provided an explanation of the method used to calculate the motor revolution speed of pure water supply device 7 at Step S41b, using FIG. 18.

The relationship between the motor revolution speed of pure water supply device 7 and the supply flow rate of the pure water used for humidifying and the atmospheric pressure is derived by previous experiments. Based on this relationship, the motor revolution speed N_{pwr}_{_{—}}_{idle}[rpm] of pure water supply device 7 for when a supply flow rate of Q_{pwr}_{_{—}}_{idle}′[L/min] is supplied after the correction has been made and the atmospheric pressure is 1 atmosphere, and the motor revolution speed N_{pwr}_{_{—}}_{idle}′[rpm] for after the correction has been made in pure water supply device 7 for when a supply flow rate of Q_{pwr}_{_{—}}_{idle}′[L/min] is supplied after the pure water used for humidifying has been corrected and the atmospheric pressure detected at Step S1 in FIG. 12 is Pᵢₙ_{_{—}}ₐᵢᵣ[kPa], are calculated.

Based on the above, the amount of correction in the motor revolution speed A N_{pwr}_{_{—}}_{idle}[rpm] of pure water supply device 7 when in idle operation is as shown in Formula (15).

[Formula 15]

ΔN_{pwr}_{_{—}}_{idle}=N_{pwr}_{_{—}}_{idle}′−N_{pwr}_{_{—}}_{idle}[rpm] (15)

Next is provided an explanation of the method used to estimate the torque required by the motor of pure water supply device 7 in Step S42b of FIG. 21.

The motor revolution speed N_{pwr}_{_{—}}_{idle}′[rpm] for after the correction has been made in pure water supply device 7 when in idle operation becomes Tr_{pwr}_{_{—}}_{idle}′[Nm] for the required motor torque for pure water supply device 7 required at an output of t_{pwr}_{_{—}}_{idle}[sec] for normal idle return time, the load to the motor of pure water supply device 7 becomes RL_{pwr}[Nm] and the inertia for the motor of pure water supply device 7 becomes I_{pwr}[kg·m̂2]. Also, since motor load RL_{pwr}[Nm] for pure water supply device 7 is a function of the motor revolution speed N_{pwr}[rpm] and the pressure ratio Pr_{pwr}[−] of pure water supply device 7, it can be represented according to Formula (16).

[Formula 16]

RL_{pwr}=RL_{pwr}(N_{pwr},Pr_{pwr}) (16)

When the motor revolution speed N_{pwr}_{_{—}}_{idle}′[rpm] for after the correction has been made in pure water supply device 7 when in idle operation is converted to a motor angle speed of ω_{pwr}_{_{—}}_{idle}′[rad/sec], it is as shown in Formula (17).

[Formula 17]

ω_{pwr}_{_{—}}_{idle}′=N_{pwr}_{_{—}}_{idle}′×(2×π)/60 (17)

Motor angle speed ω_{pwr}_{_{—}}_{idle}′[rad/sec] can further be represented by Formula (18).

[Formula 18]

ω_{pwr}_{_{—}}_{idle}′=∫₀^{pwr}^{_{—}}^{idle}(Tr_{pwr}_{_{—}}_{idle}′−RL_{pwr})/I_{pwr}·dt (18)

Formula (17) combined with Formula (18) becomes Formula (19).

[Formula 19]

N_{pwr}_{_{—}}_{idle}′×(2×π)/60=∫^{pwr}^{_{—}}^{idle}(Tr_{pwr}_{_{—}}_{idle}′−RL_{pwr})/I_{pwr}·dt (19)

Formula (19) can be further expanded into Formula (20-1) and Formula (20-2) to make Tr_{pwr}_{_{—}}_{idle}′=kt.

$$\begin{matrix}Formula ( 20 ) & \\ {N}_{pwr\_idle}^{′} \times ( 2 \times π ) / 60 = {[ \frac{{kt}^{2}}{2} \times \frac{1}{{I}_{pwr}} ]}_{0}^{{t}_{pwr\_idle}} - {\int }_{0}^{{t}_{pwr\_idle}} {RL}_{pwr} / {I}_{pwr} \cdot d t & ( 20 \text{-} 1 ) \\ k = ( {N}_{pwr\_idle}^{′} \times ( 2 \times π ) / 60 + {\int }_{0}^{{t}_{pwr\_idle}} {RL}_{pwr} / {I}_{pwr} \cdot d t ) \times 2 \times {I}_{pwr} / {t}_{pwr\_idle}^{2} & ( 20 \text{-} 2 )\end{matrix}$$

Therefore, since the required motor torque, Tr_{pwr}_{_{—}}_{idle}′[Nm], of pure water supply device 7 for when a motor revolution speed of N_{pwr}_{_{—}}_{idle}′[rpm] is output after the correction has been made in pure water supply device 7 when in idle operation is “k” in Formula (20-2), the amount of change ΔTr_{pwr}_{_{—}}_{idle}′[Nm/sec] in the required torque for when said required torque is output at a normal idle return time of t_{pwr}_{_{—}}_{idle}[sec] is represented by Formula (21).

[Formula 21]

ΔTr_{pwr}_{_{—}}_{idle}′=(N_{pwr}_{_{—}}_{idle}′×(2×π)/60+∫^{pwr}^{_{idle}}RL_{pwr}/I_{pwr}·dt)×2×I_{pwr}/t_{pwr}_{_{—}}_{idle}² (21)

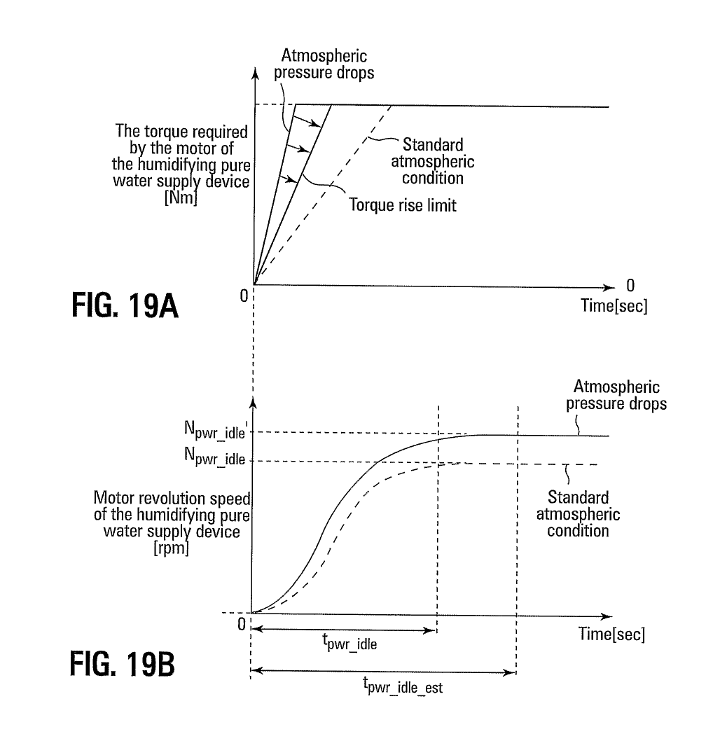

Finally, an explanation is provided for the method used to estimate the idle return time at Step S6 in FIG. 12, using FIGS. 19 (a) and (b).

If the upper limit of the torque, based on the individual properties of the motor of pure water supply device 7 is Tr_{pwr}_{_{—}}ᵤₚₚₑᵣ[Nm], and the upper limit in the amount of change in the torque is ΔTr_{pwr}_{_{—}}ᵤₚₚₑᵣ[Nm/sec], the estimated value for the idle return time t_{pwr}_{_{—}}_{idle}_{_{—}}ₑₛₜ[sec] can be calculated as shown in Formula (22). However, ΔTr_{pwr}_{_{—}}ᵤₚₚₑᵣ<ΔTr_{pwr}_{_{—}}_{idle}′.

[Formula 22]

t_{pwr}_{_{—}}_{idle}_{_{—}}ₑₛₜ−Tr_{pwr}_{_{—}}_{idle}′/ΔTr_{pwr}_{_{—}}ᵤₚₚₑᵣ (22)

As explained above, for Embodiment 4, the fluid supply device is humidifying water supply device (pure water supply device) 7 that supplies water for humidifying the oxidant gas supplied to fuel cell stack 19. Controller 13 (flow rate calculation means) functions as the humidifying water flow rate calculation means that calculates the flow rate of the pure water that is required to realize idle operation. In addition, controller 13 (motor revolution speed calculation means) calculates the motor revolution speed of pure water supply device 7 that is required to realize the flow rate of the pure water that was calculated by the humidifying water flow rate calculation means. In other words, it estimates the pressure of the water taken in by pure water supply device 7 based on the atmospheric pressure, corrects the motor revolution speed of pure water supply device 7, which realizes the flow rate of the pure water used to humidify the oxidant gas supplied to fuel cell stack 19 based on the pressure of the pure water that has been taken in, and estimates the idle return time based on the motor revolution speed for after the correction has been made. And as a result, a very accurate idle return time can be achieved.

The fuel cell system further comprises an intake humidifying water pressure estimation means that estimates the pressure of the pure water taken in by pure water supply device 7 based on the atmospheric pressure, and discharge humidifying water pressure detection means (pressure sensor) 50 that detects the pressure of the water discharged by pure water supply device 7. Controller 13 (idle return time estimation means 63) calculates the pressure ratio of the pressure estimated by the intake humidifying water pressure estimation means and the pressure detected by pressure sensor 50, corrects the motor revolution speed based on the pressure ratio, and estimates the idle return time based on the motor revolution speed for after the correction has been made. In other words, idle return time estimation means 63 calculates the pressure ratio of the pressure estimated by the intake humidifying water pressure estimation means and the pressure detected by the discharge humidifying water pressure detection means, corrects the motor revolution speed based on this pressure ratio, and estimates the idle return time based on the motor revolution speed for after the correction has been made. And as a result, a very accurate idle return time can be achieved.

### Embodiment 5

As was the case with Embodiment 4, Embodiment 5 also uses pure water supply device 7 to supply the pure water that humidifies the oxidant gas supplied to fuel cell stack 19 as another example of a “fluid supply device (PP system auxiliary device)”.

The explanations pertaining to FIG. 1 through FIG. 3, FIG. 11, FIG. 12, FIG. 17 through FIG. 19 and FIG. 21 are the same as those for Embodiment 1 and 4 and have therefore been omitted.

The summary of the operation is the same as that for Embodiment 4.

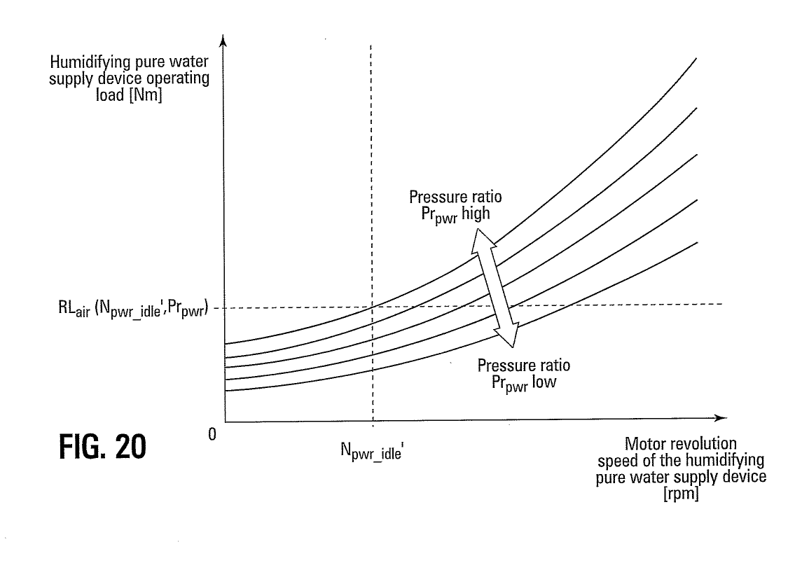

Next is provided an explanation of the method used to estimate the required torque of pure water supply device 7 in Step S42b of FIG. 21, using FIG. 20.

First, the pressure P_{pwr}_{_{—}}ᵢₙ[kPa] of the pure water taken in by pure water supply device 7 is obtained. The density of the pure water should be P_{pwr}[kg/m̂3] and the water level from pure water reservoir 39 to pure water supply device 7 should be h_{pwr}[m]. Measurements can be taken by installing a water level sensor inside of pure water reservoir 39, for instance. The intake pure water pressure P_{pwr}_{_{—}}ᵢₙ[kPa] of pure water supply device 7 can be calculated from the atmospheric pressure Pᵢₙ_{_{—}}ₐᵢᵣ[kPa] detected at Step S1 in FIG. 12, as shown in Formula 23. In this Formula, “g” represents the acceleration of gravity [m/ŝ2].

[Formula 23]

P_{pwr}_{_{—}}ᵢₙ=P_{pwr}×g×h_{pwr}+Pᵢₙ_{_{—}}ₐᵢᵣ (23)

Then, pressure sensor 50, which detects the pressure of the pure water of pure water supply device 7, detects the pressure P_{pwr}_{_{—}}ₒᵤₜ[kPa] of the pure water discharged by pure water supply device 7 and calculates the pressure ratio Pr_{pwr}[−] of pure water supply device 7, as explained for Embodiment 4, from intake pure water pressure P_{pwr}_{_{—}}ᵢₙ[kPa] calculated in Formula (23) to obtain Formula (24).

[Formula 24]

Pr_{pwr}=P_{pwr}_{_{—}}ₒᵤₜ/P_{pwr}_{_{—}}ᵢₙ (24)

Then, Formula (16), which represents motor load RL_{pwr}[Nm] of pure water supply device 7, as explained for Embodiment 4, is derived by previous experiments from the relationship between motor revolution speed N_{pwr}[rpm] of pure water supply device 7 and pressure ratio Pr_{pwr}[−] of pure water supply device 7, and motor load RL_{pwr}[Nm] of pure water supply device 7 is calculated from Formula (24) and motor revolution speed N_{pwr}_{_{—}}_{idle}′[rpm] for after the correction has been made in pure water supply device 7 when in idle operation, as calculated in Step S41b in FIG. 21.

The same method that was used for Embodiment 4 can be used for other arithmetic calculations of the estimated value for the idle return time t_{pwr}_{_{—}}_{idle}_{_{—}}ₑₛₜ[sec].

### Embodiment 6

For Embodiment 6, cooling liquid supply device (cooling water supply device) 37, which supplies cooling liquid (cooling water) for cooling fuel cell stack 19 is used as yet another example of a “fluid supply device (PP system auxiliary device)”.

The explanations pertaining to FIG. 1 through FIG. 3 and FIG. 12 are the same as those for Embodiment 1 and have therefore been omitted.

The summary of the operation is the same as that for Embodiment 4. For Embodiment 6 of the present invention, a fuel cell system is installed in a vehicle with fuel cell stack 19 as the main power source. When the state of the vehicle is determined to be in a predetermined idle state, the idle stopping means stops cooling water supply device 37, or stops power generation of fuel cell stack 19 due to low electrode load operation and puts it in “idle stopped state”.

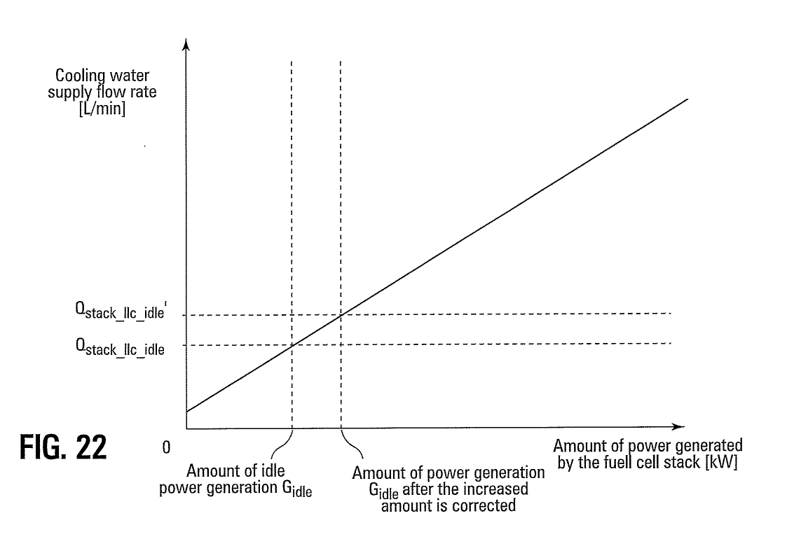

Next, an explanation is provided of the method used to calculate the target supply flow rate of cooling water supply device 37 when in idle operation for Step S2 in FIG. 12, using FIG. 22. The relationship between the amount of power generated by fuel cell stack 19 and the cooling water flow rate for cooling fuel cell stack 19 is derived by previous experiments. In addition, the supply flow rate of the cooling water for when fuel cell stack 19 is generating an idle power generation amount of G_{idle}[kW], as explained in Embodiment 1, should be Q_{stack}_{_{—}}_{llc}_{_{—}}_{idle}[l/min].

Next, an explanation is provided for one example of a method for correcting the supply flow rate of cooling water supply device 37 when in idle operation for Step S3 in FIG. 12, using FIG. 22. For example, the operating point of the PP system auxiliary device for when in idle operation is corrected by increasing the amount due to a decrease in the atmospheric pressure and as a result, the amount of power consumed by the PP system auxiliary device increases, the amount of idle power generation that must be generated by fuel cell stack 19 increases to G_{idle}′[kW] and the supply flow rate for after the correction has been made in the cooling water when in idle operation becomes Q_{stack}_{_{—}}_{llc}_{_{—}}_{idle}′[L/min].

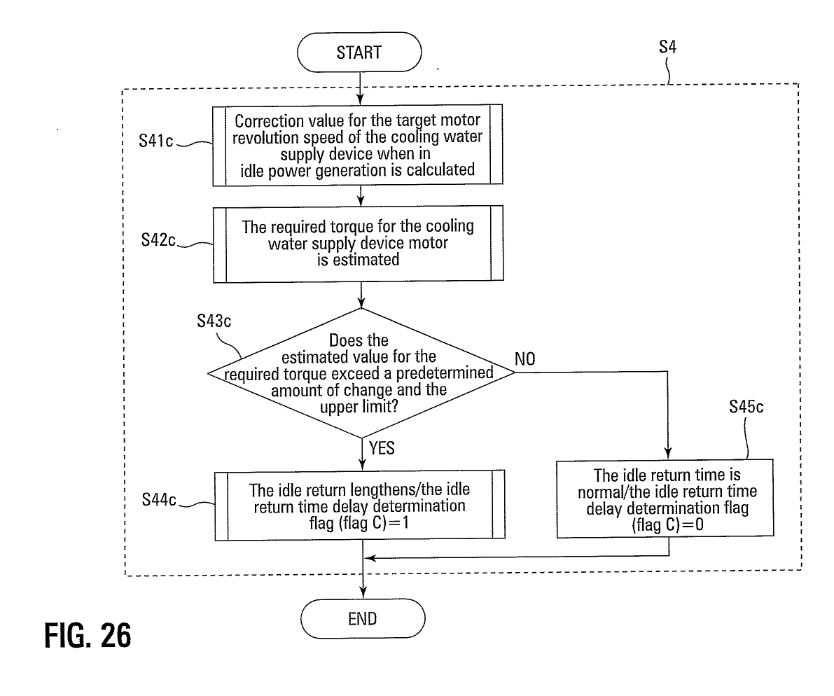

Calculation-Control Flow Chart for the Motor Revolution Speed of the Cooling Water Supply Device for the Fuel Cell Stack when in Idle Operation (FIG. 26)

Next is provided an explanation of the method used to calculate the determination flag for determining whether or not there is a delay in the idle return time for Step S4 in FIG. 12, using the flowchart in FIG. 26.

At Step S41c, the motor revolution speed of cooling water supply device 37 that realizes the target supply flow rate after the correction has been made is calculated from the target supply flow rate for when after the correction has been made in cooling water supply device 37 when in idle operation that was calculated at Step S3 of FIG. 12. At Step S42c, the amount of torque required for the output of the motor of cooling water supply device 37 for when the motor is rotated at the target idle return time is estimated from a motor revolution speed of 0 rpm up until the motor revolution speed calculated at Step S41c. At Step S43c, it is determined whether or not the estimated value of the torque required by the motor of cooling water supply device 37 estimated at Step S42c exceeds the upper limit of torque and the upper limit of the amount of change in torque based on the individual properties of the motor of cooling water supply device 37. At Step S43c, if the estimated value of the torque required by the motor is determined to be more than the upper limit of torque and the upper limit of the amount of change in torque based on the individual properties of the motor (YES at Step S43c), the process proceeds to Step S44c, the idle return time delay determination flag (flag C) is set to “1”, and the process is ended. On the other hand, if the estimated value of the torque required by the motor that was calculated at Step S43c is determined to not be more than the upper limit of torque and the upper limit in the amount of change in torque based on the individual properties of the motor (NO at Step S43c), the process proceeds to Step S45c, the idle return time delay determination flag (flag C) is set to “0”, and the process is ended.

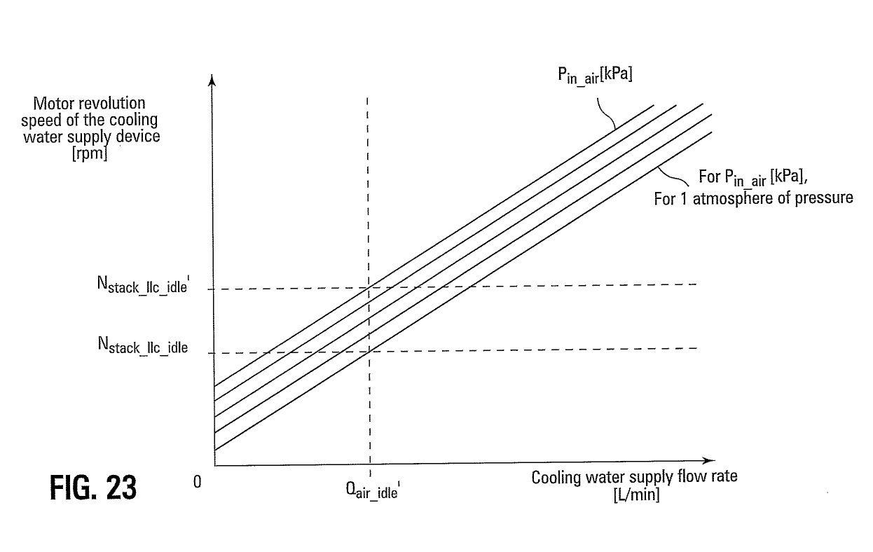

Next is provided an explanation of the method used to calculate the motor revolution speed of cooling water supply device 37 for Step S41c using FIG. 23. The relationship between the motor revolution speed of cooling water supply device 37, the supply flow rate of the cooling water and the atmospheric pressure is derived by previous experiments. Based on this relationship, the motor revolution speed N_{stack}_{_{—}}_{llc}_{_{—}}_{idle}[rpm] for when a supply flow rate of Q_{stack}_{_{—}}_{llc}_{_{—}}_{idle}′[L/min] is supplied after the correction has been made in the cooling water and the atmospheric pressure is 1 atmosphere, and the motor revolution speed N_{stack}_{_{—}}_{llc}_{_{—}}_{idle}′[rpm] for after the correction has been made and a supply flow rate of Q_{stack}_{_{—}}_{llc}_{_{—}}_{idle}′[L/min] is supplied after the correction has been made in the cooling water, and the atmospheric pressure detected at Step S1 in FIG. 12 is Pᵢₙ_{_{—}}ₐᵢᵣ[kPa] are calculated.

Based on the above, the amount of correction in the target motor revolution speed ΔN_{stack}_{_{—}}_{llc}_{_{—}}_{idle}[rpm] of cooling water supply device 37 when in idle operation is as shown in Formula (25).

[Formula 25]

ΔN_{stack}_{_{—}}_{llc}_{_{—}}_{idle}=N_{stack}_{_{—}}_{llc}_{_{—}}_{idle}′−N_{stack}_{_{—}}_{llc}_{_{—}}_{idle}[rpm] (25)

Next is provided an explanation of the method used to estimate the torque required by the motor of cooling water supply device 37 at Step S42c of FIG. 26.

The motor revolution speed N_{stack}_{_{—}}_{llc}_{_{—}}_{idle}′[rpm] for after the correction has been made in cooling water supply device 37 should be Tr_{stack}_{_{—}}_{llc}_{_{—}}_{idle}′[Nm] for the required motor torque for cooling water supply device 37 required at an output of t_{stack}_{_{—}}_{llc}_{_{—}}_{idle}[sec] for normal idle return time, the load to the motor of cooling water supply device 37 should be RL_{stack}_{_{—}}_{llc}[Nm] and the inertia for the motor of cooling water supply device 37 should be I_{stack}_{_{—}}_{llc}[kg·m̂2]. And, since the motor load RL_{stack}_{_{—}}_{llc}[Nm] for cooling water supply device 37 is a function of the motor revolution speed N_{stack}_{_{—}}_{llc}[rpm] and the pressure ratio Pr_{stack}_{_{—}}_{llc}[−] of cooling water supply device 37, it can be represented as Formula (26).

[Formula 26]

RL_{stack}_{_{—}}_{llc}=RL_{stack}_{_{—}}_{llc}(N_{stack}_{_{—}}_{llc},Pr_{stack}_{_{—}}_{llc}) (26)

In addition, when the motor revolution speed N_{stack}_{_{—}}_{llc}_{_{—}}_{idle}′[rpm] for after the correction has been made in cooling water supply device 37 is converted to a motor angle speed of ω_{stack}_{_{—}}_{llc}_{_{—}}_{idle}′[rad/sec], it is as shown in Formula (27).

[Formula 27]

ω_{stack}_{_{—}}_{llc}_{_{—}}_{idle}′=N_{stack}_{_{—}}_{llc}_{_{—}}_{idle}′×(2×π)/60 (27)

Motor angle speed ω_{stack}_{_{—}}_{llc}_{_{—}}_{idle}′[rad/sec] can further be represented by Formula (28).

[Formula 28]

ω_{stack}_{_{—}}_{llc}_{_{—}}_{idle}′=∫₀^{stack}^{_{—}}^{llc}^{_{—}}^{idle}ITr_{stack}_{_{—}}_{llc}_{_{—}}_{idle}′−RL_{stack}_{_{—}}_{llc})/I_{slack}_{_{—}}_{llc}·dt (28)

Formula (27) combined with Formula (28) becomes Formula (29).

[Formula 29]

N_{stack}_{_{—}}_{llc}_{_{—}}_{idle}′×(2×π)/60=∫₀^{stack}^{_{—}}^{llc}^{_{—}}^{idle}(Tr_{stack}_{_{—}}_{llc}_{_{—}}_{idle}′−RL_{stack}_{_{—}}_{llc})/I_{stack}_{_{—}}_{llc}·dt (29)

Formula (29) further evolves into Formula (30-1) and Formula (30-2) for Tr_{stack}_{_{—}}_{llc}_{_{—}}_{idle}′=kt.

$$\begin{matrix}Formula ( 30 ) & \\ {N}_{stack\_llc \_idle}^{′} \times ( 2 \times π ) / 60 = {[ \frac{{kt}^{2}}{2} \times \frac{1}{{I}_{stack\_llc}} ]}_{0}^{{t}_{stack\_llc \_idle}} - {\int }_{0}^{{t}_{stack\_llc \_idle}} {RL}_{stack\_llc} / {I}_{stack\_llc} \cdot d t & ( 30 \text{-} 1 ) \\ k = ( {N}_{stack\_llc \_idle}^{′} \times ( 2 \times π ) / 60 + {\int }_{0}^{{t}_{stack\_llc \_idle}} {RL}_{stack\_llc} / {I}_{stack\_llc} \cdot d t ) \times 2 \times {I}_{stack\_llc} / {t}_{stack\_llc \_idle}^{2} & ( 30 \text{-} 2 )\end{matrix}$$

Therefore, since the required motor torque Tr_{stack}_{_{—}}_{llc}_{_{—}}_{idle}′[Nm] for when a motor revolution speed of N_{stack}_{_{—}}_{llc}_{_{—}}_{idle}′[rpm] is output after the correction has been made in cooling water supply device 37 is “k” in Formula (30-2), the amount of change, A Tr_{stack}_{_{—}}_{llc}_{_{—}}_{idle}′[Nm/sec], in the required torque for when said required torque is output at a normal idle return time of t_{stack}_{_{—}}_{llc}_{_{—}}_{idle}[sec] can be represented by Formula (31).

[Formula 31]

ΔTr_{_{—}}_{stack}_{_{—}}_{llc}_{_{—}}_{idle}′=(N_{stack}_{_{—}}_{llc}_{_{—}}_{idle}′×(2×π)/60+∫₀^{stack}^{_{—}}^{llc}^{_{—}}^{idle}RL_{stack}_{_{—}}_{llc}/I_{stack}_{_{—}}_{llc}·dt)×2×I_{stack}_{_{—}}_{llc}/t_{stack}_{_{—}}_{llc}_{_{—}}_{idle}² (31)

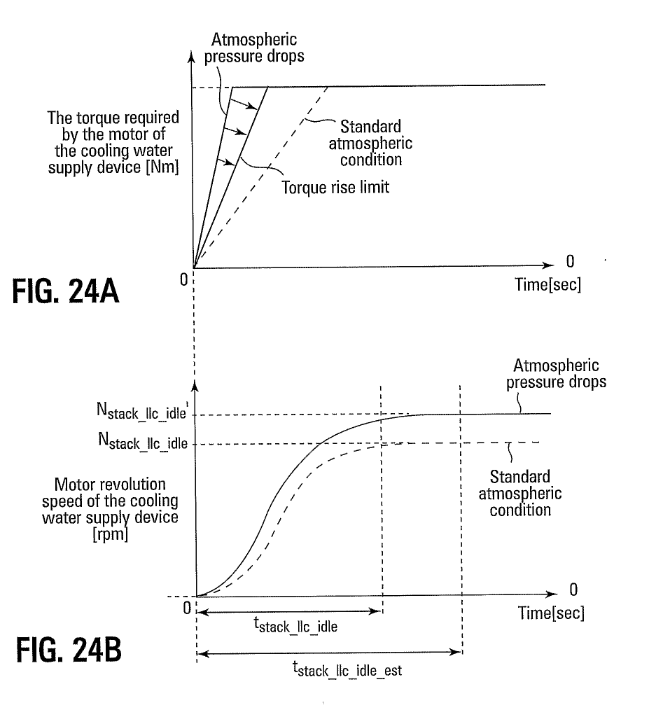

Finally, an explanation is provided for the method used to estimate the idle return time at Step S6 in FIG. 12, using FIG. 24. If the upper limit of the torque, based on the individual properties of the motor of cooling water supply device 37 is Tr_{stack}_{_{—}}_{llc}_{_{—}}ᵤₚₚₑᵣ′[Nm], and the upper limit in the amount of change in the torque is ΔTr_{stack}_{_{—}}_{llc}_{_{—}}ᵤₚₚₑᵣ′[Nm/sec], the estimated value for the idle return time t_{stack}_{_{—}}_{llc}_{_{—}}_{idle}_{_{—}}ₑₛₜ[sec] can be calculated as shown in Formula (32). However, it should be noted that ΔTr_{stack}_{_{—}}_{llc}_{_{—}}ᵤₚₚₑᵣ<ΔTr_{stack}_{_{—}}_{llc}_{_{—}}_{idle}′.

[Formula 32]

t_{stack}_{_{—}}_{llc}_{_{—}}_{idle}_{_{—}}ₑₛₜ=Tr_{stack}_{_{—}}_{llc}_{_{—}}_{idle}′/ΔTr_{stack}_{_{—}}_{llc}_{_{—}}ᵤₚₚₑᵣ (32)

As explained above, for Embodiment 6, the fluid supply device is cooling water supply device 37 that supplies cooling water for cooling fuel cell stack 19. Controller 13 (flow rate calculation means) functions as the cooling liquid flow rate calculation means that calculates the flow rate of the cooling liquid that is required to realize idle operation. And, controller 13 (motor revolution speed calculation means) calculates the motor revolution speed of cooling water supply device 37 that is required to realize the flow rate of the cooling liquid that was calculated by the cooling liquid flow rate calculation means. In other words, it estimates the intake cooling water pressure of cooling water supply device 37 based on the atmospheric pressure, corrects the motor revolution speed of cooling water supply device 37 that realizes the flow rate of the cooling water that cools fuel cell stack 19 based on the pressure of the cooling water that has been taken in, and estimates the idle return time based on the motor revolution speed for after the correction has been made. And as a result, a very accurate idle return time can be achieved.

The fuel cell system further comprises an intake cooling liquid pressure estimation means that estimates the pressure of the cooling liquid taken in by cooling water supply device 37 based on the atmospheric pressure, and discharge cooling water pressure detection means (pressure sensor 51) that detects the pressure of the cooling liquid discharged by cooling water supply device 37. Idle return time estimation means 63 calculates the pressure ratio of the pressure estimated by the intake cooling liquid pressure estimation means and the pressure detected by pressure sensor 51, corrects the motor revolution speed based on this pressure ratio, and estimates the idle return time based on the motor revolution speed for after the correction has been made. In other words, it detects the discharge cooling water pressure of cooling water supply device 37 of fuel cell stack 19, calculates the pressure ratio of cooling water supply device 37 from the discharge cooling water pressure and the intake cooling water pressure, further corrects the command value of the motor revolution speed of cooling water supply device 37 from the aforementioned pressure ratio, and estimates the idle return time based on the aforementioned corrected amount. In this manner, a very accurate idle return time can be achieved.

### Embodiment 7

For Embodiment 7, cooling liquid supply device (cooling water supply device) 37, which supplies cooling liquid (cooling water) for cooling fuel cell stack 19 is used as yet another example of a “fluid supply device (PP system auxiliary device)”.

The explanations pertaining to FIG. 1 through FIG. 3, FIG. 12, FIG. 22 through FIG. 24 and FIG. 26 are the same as those for Embodiment 1 and 6 and have therefore been omitted.

The summary of the operation is the same as that for Embodiment 6.

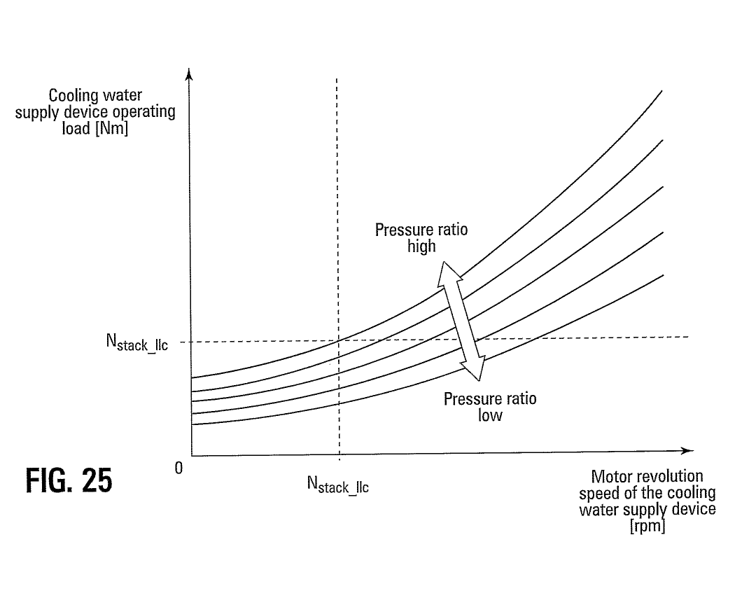

Next is provided an explanation of the method used to estimate the required torque for cooling water supply device 37 in Step S42c of FIG. 26, using FIG. 25.

First, the pressure P_{stack}_{_{—}}_{llc}_{_{—}}ᵢₙ[kPa] of the cooling water taken in by cooling water supply device 37 is obtained. The density of the cooling water should be P_{stack}_{_{—}}_{llc}[kg/m̂3] and the water level from cooling water reservoir 40 to cooling water supply device 37 should be h_{stack}_{_{—}}_{llc}[m]. Water level h_{stack}_{_{—}}_{llc}[m] can be measured by installing a water level sensor inside of cooling water reservoir 40, for example. Intake cooling water pressure P_{stack}_{_{—}}_{11c}_{_{—}}ᵢₙ[kPa] of cooling water supply device 37 can be calculated from atmospheric pressure water level Pᵢₙ_{_{—}}ₐᵢᵣ[kPa] detected at Step S1 in FIG. 12, as shown in Formula (33). In this formula, the acceleration of gravity is expressed as g[m/ŝ2].

[Formula 33]

P_{stack}_{_{—}}_{llc}_{_{—}}ᵢₙ=P_{stack}_{_{—}}_{llc}×g×h_{stack}_{_{—}}_{llc}+Pᵢₙ_{_{—}}ₐᵢᵣ (33)

Next, the pressure P_{stack}_{_{—}}_{llc}_{_{—}}ₒᵤₜ[kPa] of the cooling water discharged by cooling water supply device 37 is detected by pressure sensor 51, which detects the pressure of the cooling water of cooling water supply device 37. The pressure ratio Pr_{stack}_{_{—}}_{llc}[−] of cooling water supply device 37, which was explained in Embodiment 6, can be calculated from the intake cooling water pressure P_{stack}_{_{—}}_{llc}_{_{—}}ᵢₙ[kPa] calculated in Formula (33), as shown in Formula (34).

[Formula 34]

P_{stack}_{_{—}}_{llc}=P_{stack}_{_{—}}_{llc}_{_{—}}ₒᵤₜ/P_{stack}_{_{—}}_{llc}_{_{—}}ᵢₙ (34)

Next, Formula (26), which expresses the motor load RL_{stack}_{_{—}}_{llc}[Nm] for cooling water supply device 37 explained in Embodiment 6 is derived by previous experiments from the relationship between the motor revolution speed N_{stack}_{_{—}}_{llc}[rpm] of cooling water supply device 37 and the pressure ratio Pr_{stack}_{_{—}}_{llc}[−] of cooling water supply device 37. Motor load RL_{stack}_{_{—}}_{llc} [Nm] for cooling water supply device 37 is calculated from the motor revolution speed N_{stack}_{_{—}}_{llc}_{_{—}}_{idle}′[rpm] for after the correction has been made in cooling water supply device 37, which was calculated at Step S41c in FIG. 26 and Formula (34).

The same method that was used for Embodiment 6 can be used for other arithmetic calculations of the estimated value for the idle return time t_{stack}_{_{—}}_{llc}_{_{—}}_{idle}_{_{—}}ₑₛₜ[sec].

### Embodiment 8

Embodiment 8 uses oxidant gas supply device 3, pure water supply device 7 and cooling water supply device 37 as the “fluid supply device (PP system auxiliary device)”.

The explanations pertaining to FIG. 1 through FIG. 26 are the same as those for Embodiment 1 through 7 and have therefore been omitted.

The summary of the operation is the same as that for Embodiment 1 through 7. Next is provided an explanation of the method used to estimate the idle return time for Step S6 in FIG. 12. The highest value for the idle return time from estimated value tₐᵢᵣ_{_{—}}_{idle}_{_{—}}ₑₛₜ[sec] of the idle return time for oxidant gas supply device 3 explained in Embodiment 1, estimated value t_{pwr}_{_{—}}_{idle}_{_{—}}ₑₛₜ[sec] of the idle return time for pure water supply device 7 explained in Embodiment 4, and estimated value t_{stack}_{_{—}}_{llc}_{_{—}}_{idle}_{_{—}}ₑₛₜ[sec] of the idle return time for cooling water supply device 37 explained in Embodiment 6 is used for the estimated value.

### Embodiment 9

The basic composition of the Embodiment of the present invention is a fuel cell system comprising a fuel cell that generates power by supplying fuel gas containing hydrogen and oxidant gas containing oxygen, and further comprising a PP system auxiliary device control means 62 as an idle stopping means that stops power generation of the fuel cell, which is in idle operation, and puts it in an idle stopped state, an atmospheric pressure detection means 61 that detects the atmospheric pressure of the periphery of the fuel cell, and a power consumption estimation means 64 that estimates the power consumption of the auxiliary device that constitutes the fuel cell system at idle return time from the time at which the fuel cell that is in the idle stopped state starts the start-up operation until it returns to idle operation based on the atmospheric pressure detected by the atmospheric pressure detection means 61.

The PP (power plant) system auxiliary device control means 62 controls the oxidant gas supply device as the auxiliary device based on the atmospheric pressure detected by atmospheric pressure detection means 61. The power consumption estimation means 64 estimates the idle return time of the fuel cell stack based on the atmospheric pressure detected by atmospheric pressure detection means 61 and the engine revolution speed command value of the auxiliary device (oxidant gas supply device) controlled by the PP system auxiliary device control means 62.

As was the case with Embodiment 1, Embodiment 9 also uses oxidant gas supply device 3 to supply oxidant gas to the fuel cell stack as an example of the “fluid supply device (PP System auxiliary device)”.

Next is provided an explanation of the operation of the fuel cell system that pertains to Embodiment 9.

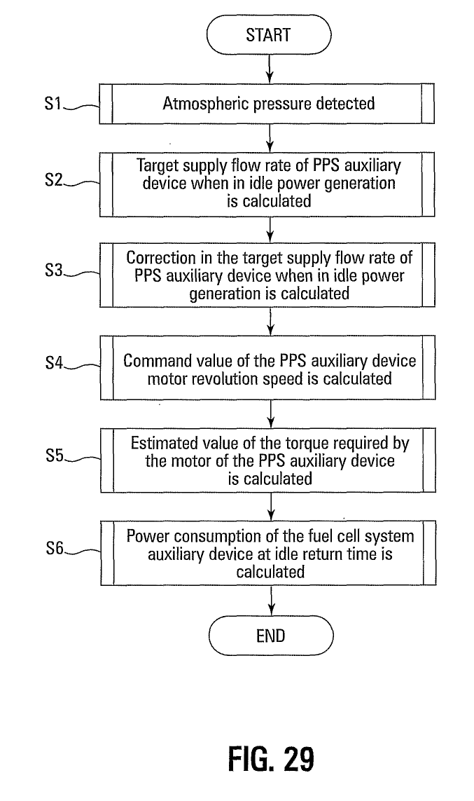

Main Flowchart (FIG. 29)

First, an explanation is provided of the entire operation with reference to the flowchart in FIG. 29. The control method of the fuel cell system estimates the power consumption of the PP system auxiliary device during idle return time from the atmospheric pressure detected by pressure sensor 16. The main process content of FIG. 29 is executed at predetermined time increments (for instance, every 10 ms) from the time of initiating operation of the fuel cell.

At Step S1, pressure sensor 16 detects the atmospheric pressure, at Step S2, the target flow rate of the fluid (oxidant gas) supplied while the auxiliary device (oxidant gas supply device 3) of the PP system is in idle operation is calculated, and at Step 3, the target supply flow rate is corrected based on the target supply flow rate of oxidant gas supply device 3 when in idle operation calculated at Step S2 and the atmospheric pressure detected at Step S1. At Step S4, the command value of the motor revolution speed of oxidant gas supply device 3 is calculated based on the supply flow rate for after oxidant gas supply device 3 has been corrected when in idle operation calculated at Step S3. Step S5 estimates the torque required by the motor of oxidant supply device 3 that is required to realize the command value of the motor revolution speed of oxidant gas supply device 3 for a predetermined idle return time that was calculated at Step S4. Step S6 calculates the power consumption of oxidant gas supply device 3 at idle return time based on the command value of the motor revolution speed of oxidant gas supply device 3 calculated at Step S4 and the estimated value of the torque required by the motor of oxidant gas supply device 3 calculated at Step S5, and the process is then ended.

Next, an explanation is provided of the process for calculating the target supply flow rate of the auxiliary device when in idle operation for Step S2, using FIG. 4. For example, when in standard atmospheric condition (1013.25 hPa, 15° C.), the supply flow rate of the oxidant gas that needs to be supplied in order to execute a predetermined power generation by fuel cell stack 19 is derived by previous experiments, and as shown in FIG. 4, the relationship between the supply flow rate of the oxidant gas and the power generation level of fuel cell stack 19 can be derived.

When the vehicle is in a predetermined idle state (a vehicle speed of 0 km/h with no requirement to charge the battery), the idle power generation level required for power generation by fuel cell stack 19 is G_{idle}[kW] shown in FIG. 4 and the target supply flow rate of the oxidant gas while in idle operation that is supplied to fuel stack 19 in order to realize this idle power generation level becomes Qₐᵢᵣ_{_{—}}_{idle}[NL/min].

The Flowchart for Calculating the Correction in the Target Supply Flow Rate of the Oxidant Gas when in Idle Operation (FIG. 13)

Next is provided an explanation of the method used to correct the target supply flow rate of oxidant gas supply device 3 in Step S3, using the flowchart in FIG. 13.

At Step S31, temperature sensor 17 detects the temperature of the oxidant gas taken in by oxidant gas supply device 3, at Step S32, the corrected value of the target supply flow rate is calculated based on the target supply flow rate of oxidant gas supply device 3 when in idle operation that was calculated at Step S2 and the atmospheric pressure detected at Step S1 of FIG. 29, and the process is ended.

Next an explanation is provided for the method used to calculate the corrected value of Step S32. For example, a description is provided for calculating when the target supply flow rate calculated at Step S2 is a normal volume flow rate [NL/min].

When the target supply flow rate of the oxidant gas calculated at Step S2 is Qₐᵢᵣ_{_{—}}_{idle}[NL/min], the atmospheric pressure detected at Step S1 is Pᵢₙ_{_{—}}ₐᵢᵣ[kPa], and the temperature of the oxidant gas detected at Step S31 is Tᵢₙ_{_{—}}ₐᵢᵣ[degC], the target supply flow rate Qₐᵢᵣ_{_{—}}_{idle}′[L/min] for after the correction has been made can be calculated according to Formula (1).

$$\begin{matrix}[ Formula 1 ] & \\ {Q}_{air\_idle}^{′} = {Q}_{air\_idle} \times \frac{101.325}{{P}_{in\_air}} \times \frac{( {T}_{in\_air} + 273.15 )}{273.15} L \text{/} min & ( 1 )\end{matrix}$$

When calculating the target supply flow rate calculated at Step S2 to be mass flow rate Qₐᵢᵣ_{_{—}}_{idle}[g/min], the oxidant gas density can be calculated according to Formula (2) provided below, and the target supply flow rate Qₐᵢᵣ_{_{—}}_{idle}′[L/min] for after the correction to the oxidant gas has been made can also be calculated according to Formula (3) provided below.

The oxidant gas density at a gaseous standard state (0° C. and 101.325 kPa) is [g/L] and therefore, the oxidant gas density [g/L] can be calculated according to Formula (2)

σ=(1.293/(1+0.00367×T_{CMP}_{_{—}}_{IN1}))×P₁/101.325[g/L] (2)

[Formula 3]

Qₐᵢᵣ_{_{—}}_{idle}′=Qₐᵢᵣ_{_{—}}_{idle}/σ (3)

Next is provided an explanation of the method used to calculate the motor revolution speed of oxidant gas supply device 3 in Step S4, using FIG. 5.

The relationship between the motor revolution speed of oxidant gas supply device 3 and the flow rate of the oxidant gas supplied to fuel cell stack 19 is derived by previous experiments with the atmospheric pressure being the parameter. Here, even if the supply rate of oxidant gas remains the same while the atmospheric pressure falls, the motor revolution speed of oxidant gas supply device 3 increases by such relationship. From this relationship, the motor revolution speed Nₐᵢᵣ_{_{—}}_{idle}[rpm] of oxidant gas supply device 3 when supplying the target supply flow rate Qₐᵢᵣ_{_{—}}_{idle}[NL/min] of the oxidant gas when in idle operation, and the target motor revolution speed Nₐᵢᵣ_{_{—}}_{idle}′[rpm] when supplying the target supply flow rate Qₐᵢᵣ_{_{—}}_{idle}′[L/min] for after the correction has been made, can be calculated.

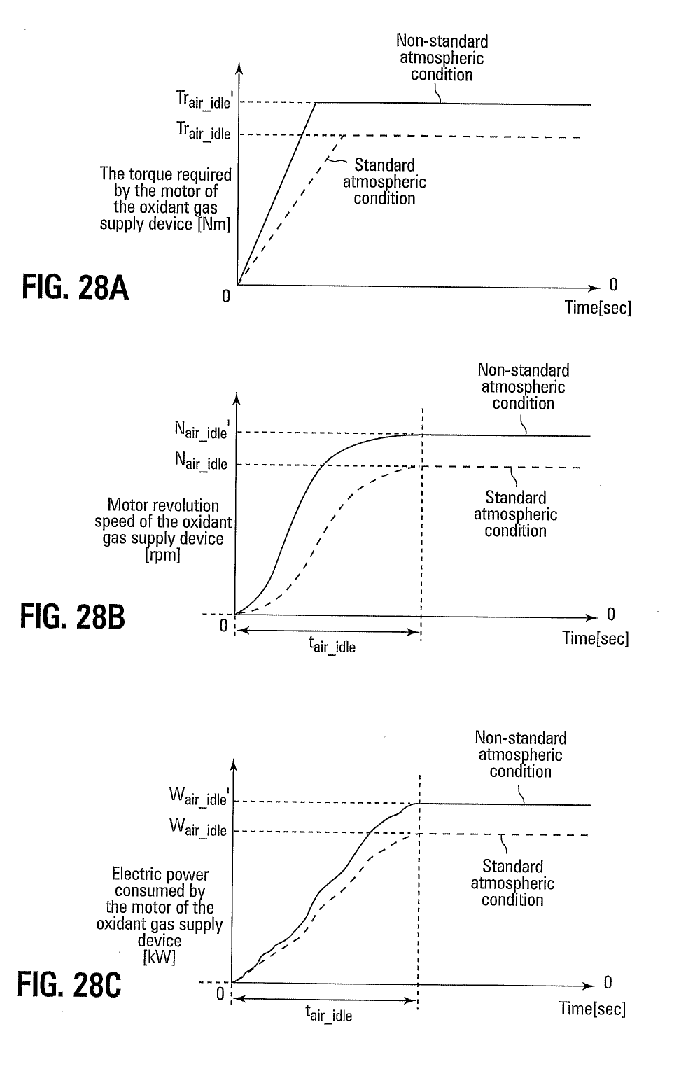

Next is provided an explanation of the method used to estimate the torque required by the motor of oxidant gas supply device 3 in Step S5 with reference made to FIG. 28.

The torque required by the motor when outputting target motor revolution speed Nₐᵢᵣ_{_{—}}_{idle}′[rpm] for after the correction has been made when in idle operation for a normal idle return time of tₐᵢᵣ_{_{—}}_{idle}[sec] is made to be Trₐᵢᵣ_{_{—}}_{idle}′[Nm], the load applied to the motor for oxidant gas supply device 3 is RLₐᵢᵣ[Nm], and the inertia of the motor for oxidant gas supply device 3 is Iₐᵢᵣ[kg·m̂2]. Further, motor load RLₐᵢᵣ[Nm] of oxidant gas supply device 3 is a function of the pressure ratio Prₐᵢᵣ[−] of oxidant gas supply device 3 and the motor revolution speed Nₐᵢᵣ[rpm], and can be expressed as shown in Formula (5).

[Formula 5]

RLₐᵢᵣ=RLₐᵢᵣ(Nₐᵢᵣ,Prₐᵢᵣ) (5)

When the target motor revolution speed Nₐᵢᵣ_{_{—}}_{idle}′[rpm] for after the correction has been made in oxidant gas supply device 3 when in idle operation is converted to motor angle speed ωₐᵢᵣ_{_{—}}_{idle}′[rad/sec], it is expressed as shown in Formula (6).

[Formula 6]

ωₐᵢᵣ_{_{—}}_{idle}′=Nₐᵢᵣ_{_{—}}_{idle}′×(2×π)/60 (6)

Furthermore, the estimated value Trₐᵢᵣ_{_{—}}_{idle}′[Nm] of the torque required by the motor of oxidant gas supply device 3 can be expressed according to Formula (35).

[Formula 35]

Tₐᵢᵣ_{_{—}}_{idle}′=I\dot{ω}ₐᵢᵣ_{_{—}}_{idle}+RLₐᵢᵣ (35)

In addition, motor angle speed ωₐᵢᵣ_{_{—}}_{idle}′[rad/sec] can be expressed as shown Formula (7).

[Formula 7]

ωₐᵢᵣ_{_{—}}_{idle}′=∫₀^{air}^{_{—}}^{idle}(Trₐᵢᵣ_{_{—}}_{idle}′−RLₐᵢᵣ)/Iₐᵢᵣ·dt (7)

Formula (6) combined with Formula (7) becomes Formula (8).

[Formula 8]

Nₐᵢᵣ_{_{—}}_{idle}′×(2×π)/60=∫₀^{air} ^{_{—}}^{idle}(Trₐᵢᵣ_{_{—}}_{idle}′−RLₐᵢᵣ)/Iₐᵢᵣ·dt (8)

In addition, when expanding the right side of Formula (8) to make Trₐᵢᵣ_{_{—}}_{idle}′=kt, it is expressed as shown in Formulae (9-1) and (9-2).

$$\begin{matrix}[ Formula 9 ] & \\ {N}_{air\_idle}^{′} \times ( 2 \times π ) / 60 = {[ \frac{{kt}^{2}}{2} \times \frac{1}{{I}_{air}} ]}_{0}^{{t}_{air\_idle}} - {\int }_{0}^{{t}_{air , idle}} {RL}_{air} / {I}_{air} \cdot d t & ( 9 \text{-} 1 ) \\ k = ( {N}_{air\_idle}^{′} \times ( 2 \times π ) / 60 + {\int }_{0}^{{t}_{air\_idle}} {RL}_{air} / {I}_{air} \cdot d t ) \times 2 \times {I}_{air} / {t}_{air\_idle}^{2} & ( 9 \text{-} 2 )\end{matrix}$$

Therefore, since the torque required by the oxidant gas supply device motor Trₐᵢᵣ_{_{—}}_{idle}′[Nm/sec] when outputting corrected value Nₐᵢᵣ_{_{—}}_{idle}′[rpm] for the target revolution speed of the oxidant gas supply device motor when in idle operation is “k” in Formula (9-2), the amount of change in the required torque ΔTrₐᵢᵣ_{_{—}}_{idle}′[Nm/sec] when outputting the required torque at normal idle return time tₐᵢᵣ_{_{—}}_{idle}[sec], is as shown in Formula (10).

[Formula 10]

ΔTrₐᵢᵣ_{_{—}}_{idle}′=(Nₐᵢᵣ_{_{—}}_{idle}′×(2×π)/60+∫₀^{air} ^{_{—}}^{idle}RLₐᵢᵣ/Iₐᵢᵣ·dt)×2×Iₐᵢᵣ/tₐᵢᵣ_{_{—}}_{idle}² (10)

Finally, an explanation is provided using FIG. 28 of the method used to calculate the power consumption of the motor of oxidant gas supply device 3 at Step S6. The relationship between the revolution speed of the motor of oxidant gas supply device 3, the torque and the motor loss is derived by previous experiments. The motor revolution speed Nₐᵢᵣ_{_{—}}_{idle}′[rpm] for after the correction has been made in oxidant gas supply device 3 at idle power generation and the motor loss Lossₐᵢᵣ_{_{—}}_{idle}′[kW] of oxidant gas supply device 3 at an estimated value of Trₐᵢᵣ_{_{—}}_{idle}′[Nm] for the torque required by the motor of oxidant gas supply device 3 can be expressed according to Formula (36).

[Formula 36]

LOSSₐᵢᵣ_{_{—}}_{idle}′=LOSSₐᵢᵣ_{_{—}}_{idle}(Nₐᵢᵣ_{_{—}}_{idle},Trₐᵢᵣ_{_{—}}_{idle}′) (36)

The power consumption Wₐᵢᵣ_{_{—}}_{idle}′[kW] of the motor of oxidant gas supply device 3 at idle return time can be expressed as shown in Formula (37).

[Formula 37]

Wₐᵢᵣ_{_{—}}_{idle}′=2×π×Nₐᵢᵣ_{_{—}}_{idle}′×Trₐᵢᵣ_{_{—}}_{idle}′/(60×1000)+LOSSₐᵢᵣ_{_{—}}_{idle}′ (37)

As explained above, the fuel cell system that pertains to Embodiment 9 comprises: fuel cell (fuel cell stack 19) that generates power by supplying a fuel gas that contains hydrogen, and an oxidant gas that contains oxygen; idle stopping means (PP system auxiliary device control means 62) that stops power generation of fuel cell stack 19 that is in idle operation and puts it in an idle stopped state; atmospheric pressure detection means 61 that detects the atmospheric pressure of the periphery of fuel cell stack 19; and power consumption estimation means 64 that estimates the power consumption of the auxiliary device (oxidant gas supply device) that constitutes the fuel cell system for the idle return time from the time at which fuel cell stack 19 that is in the idle stopped state starts the start-up operation until it returns to idle operation based on the atmospheric pressure detected by atmospheric pressure detection means 61. And, since the power consumption of the auxiliary device when at the idle return time is estimated based on the atmospheric pressure detected, very accurate power consumption can be achieved.

The fuel cell system further comprises: a fluid supply device (oxidant gas supply device 3) that supplies the fluid (oxidant gas) to fuel cell stack 19 due to the rotation of the motor; a flow rate calculation means that calculates the flow rate of the fluid that is required to realize idle operation; a motor revolution speed calculation means that calculates the motor revolution speed of the fluid supply device that is required to realize the flow rate calculated by the flow rate calculation means and a torque estimation means that estimates the torque required by the motor that is required to realize the motor revolution speed calculated by the motor revolution speed calculation means at the idle return time. In addition, power consumption estimation means 64 corrects the motor revolution speed calculated by the motor revolution speed calculation means based on the atmospheric pressure and estimates the power consumption based on the motor revolution speed for after the correction has been made and the torque estimated by the torque estimation means. In other words, it corrects the target oxidant gas flow rate supplied to the fuel cell stack in accordance with the changes in the atmospheric pressure and calculates the command value for the motor revolution speed that realizes the target flow rate for after said correction has been made. In addition, it estimates the torque required by the motor for realizing the motor revolution speed at the idle return time and then estimates the power consumed by the motor from the motor revolution speed and the required torque. As a result, very accurate power consumption can be achieved.

For Embodiment 9, the fluid supply device is oxidant gas supply device 3 that supplies oxidant gas to fuel cell stack 19. In this case, the flow rate calculation means is the oxidant gas flow rate calculation means that calculates the flow rate of the oxidant gas required to realize idle operation, and the motor revolution speed calculation means calculates the revolution speed of the motor for the oxidant gas supply device required to realize the flow rate of the oxidant gas calculated by the oxidant gas flow rate calculation means. In other words, the motor revolution speed of the oxidant gas supply device that realizes the flow rate of the oxidant gas calculated by the oxidant gas flow rate calculation means is corrected based on the atmospheric pressure and the power consumption is estimated based on the motor revolution speed for after the correction has been made. As a result, very accurate power consumption of the motor of oxidant gas supply device 3 can be achieved.

The fuel cell system further comprises oxidant gas temperature detection means (temperature sensor 17) that detects the temperature of the oxidant gas taken in by oxidant gas supply device 3 and oxidant gas density estimation means that estimates the density of the oxidant gas taken in by oxidant gas supply device 3 based on temperature detected by the oxidant gas temperature detection means and the atmospheric pressure. And then, the motor revolution speed calculation means corrects the motor revolution speed in accordance with the density estimated by the oxidant gas density estimation means. As a result, very accurate power consumption can be achieved.

The fuel cell system further comprises an oxidant gas pressure detection means that detects the pressure of the oxidant gas discharged by oxidant gas supply device 3. In addition, the torque estimation means calculates the pressure ratio between the atmospheric pressure and the pressure detected by the oxidant gas pressure detection means and corrects the torque based on this pressure ratio. As a result, very accurate power consumption can be achieved.

For Embodiment 9 of the present invention, a fuel cell system is installed in a vehicle with a fuel cell as its main power source. When the state of the vehicle is determined to be in a predetermined idle state, oxidant gas supply device 3 is stopped, the power generation of fuel cell stack 19 is stopped, and the vehicle is put into an “idle stopped state.” In addition, when the state of the vehicle is determined to be in a non-idle state, or when the residual capacity of the capacitor or battery drops below a predetermined value, oxidant gas supply device 3 operates to restart fuel cell stack 19.

Conventionally, there were various factors that caused variations in the power consumption of the fuel cell system auxiliary device such as, a drop in the atmospheric pressure, fluctuations in the current/voltage characteristics of fuel cell stack 19 and changes in the operating point of the auxiliary device of the fuel cell system that were related to these factors. In addition, since various controls (energy management control, drive motor control) performed by the fuel cell vehicle are basically performed by referencing the power consumption of the auxiliary device, if the auxiliary device power consumption varies, this is problematic in that it has a significant effect on the these controls.

Therefore, Embodiment 9 of the present invention assumes that the fuel cell system has transitioned from the idle stopped state to idle operation and considers the environmental conditions (atmospheric pressure, air temperature) when estimating the power consumption of the fuel cell system auxiliary device. As a result, the power consumption of the fuel cell system auxiliary device can be accurately estimated and vehicle control can be more accurately performed.

Furthermore, since power consumption of the fuel cell system auxiliary device can be accurately estimated at the idle return time, over discharge of the battery can be prevented and a fuel cell system and control method thereof can be provided in which the sense of discomfort in the feel of acceleration can be reduced.

### Embodiment 10

As was the case with Embodiment 9, Embodiment 10 also uses oxidant gas supply device 3 to supply oxidant gas to the fuel cell stack as an example of the “fluid supply device (PP System auxiliary device)”.

The explanations pertaining to FIG. 28, FIG. 29 and FIG. 13 are the same as those for Embodiment 9 and have therefore been omitted.

The summary of the operation is the same as that for Embodiment 9.

The Flowchart for Calculating the Target Supply Flow Rate of the Oxidant Gas Supply Device when in Idle Operation (FIG. 15)

An explanation using the flowchart in FIG. 15 is provided of the method used to calculate the target supply flow rate of oxidant gas supply device 3 when in idle operation at Step S2 in FIG. 29.

At Step S21, the current/voltage characteristics (I-V characteristics) of fuel cell stack 19 are estimated; and at Step S22, the target supply flow rate of the oxidant gas is calculated based on the I-V characteristics of fuel cell stack 19 estimated in Step S21 and the process is ended.

The Flowchart for Estimating the I-V Characteristics of the Fuel Cell Stack (FIG. 16)

An explanation using the flowchart in FIG. 16 is provided of the method used to estimate the I-V characteristics of fuel stack 19 in Step S21.

At Step S211, the temperature of fuel cell stack 19 or the temperature of the cooling water for cooling fuel cell stack 19 that is nearly the same value as the temperature of fuel cell stack 19 is detected. At Step S212, the correction coefficient kₜ[−] of the I-V characteristics of fuel cell stack 19 is calculated based on the temperature of fuel cell stack 19 detected in step S211. At Step S213, the total power generation time of fuel cell stack 19 is estimated; and at Step S214, the correction coefficient kₖ[−] of the I-V characteristics of fuel cell stack 19 are calculated based on the estimated value of the total power generation time of fuel cell stack 19 estimated in Step S213. At Step S215, the I-V characteristics of fuel cell stack 19 are calculated from the correction coefficient kₜ[−] of the I-V characteristics calculated in Step S212, the correction coefficient kₖ[−] of the I-V characteristics calculated in Step S214 and the ideal I-V characteristics of fuel cell stack 19, and the process is ended.

Next, an explanation using FIG. 7 (a) and FIG. 7(b) is provided of the method used to calculate the correction coefficient kₜ[−] based on the temperature (cooling water temperature) of fuel cell stack 19 in Step S212.

The relationship between the independent temperature of fuel cell stack 19, or the temperature of the cooling water of fuel cell stack 19, and the I-V characteristics of fuel cell stack 19 is derived by previous experiments as shown in FIG. 7 (a). Further, the correction coefficient kₜ[−] is derived from this relationship as shown in FIG. 7 (b) for ideal I-V characteristics of fuel cell stack 19.

Next, an explanation using FIG. 8 (a) and FIG. 8 (b) is provided of the method used to calculate the correction coefficient kₖ[−] based on the total power generation time of fuel cell stack 19 in Step S214.

The relationship between the total power generation time of fuel cell stack 19 and the I-V characteristics of fuel cell stack 19 is derived by previous experiments as shown in FIG. 8 (a). Further, the correction coefficient kₖ[−] is derived from this relationship as shown in FIG. 8 (b) for the I-V characteristics of fuel cell stack 19.

In addition, an explanation using FIG. 9 is provided of the method used to estimate the I-V characteristics of fuel cell stack 19 in Step S215.

Regarding the ideal I-V characteristics of fuel cell stack 19, the I-V characteristics V_{stack}_{_{—}}ᵣₑₐₗ(C) of fuel cell stack 19 are estimated, according to Formula (12), from the correction coefficient kₜ[−] based on the temperature (cooling water temperature) of fuel cell stack 19 calculated in Step S212, the correction coefficient kₖ[−] based on the total power generation time of fuel cell stack 19 calculated in Step S214, and the stack voltage V_{stack}_{_{—}}_{ideal}(C) when drawing the prescribed current C[A] under the ideal I-V characteristics of fuel cell stack 19.

[Formula 12]

V_{stack}_{_{—}}ᵣₑₐₗ(C)=kₜ×kₖ×V_{stack}_{_{—}}_{ideal}(C) (12)

In addition to the method used to estimate the I-V characteristics provided above, another method for calculating the I-V characteristics of a fuel cell stack would be to learn the I-V characteristics during the start-up of fuel cell stack 19.

Next, an explanation using FIG. 10 (a) and FIG. 10 (b) is provided of the method used to calculate the target supply flow rate of oxidant gas supply device 3 in Step S22.

The relationship between the ideal I-V characteristics of fuel cell stack 19 and the estimated value of the I-V characteristics calculated according to Formula (13) is shown in FIG. 10 (a). In addition, the current drawn from fuel cell stack 19 when an idle power generation level of G_{idle}[kW] is generated for each I-V characteristic becomes C_{idle}_{_{—}}_{ideal}[A] for the ideal I-V characteristics and C_{idle}_{_{—}}ₑₛₜ[A] for the I-V characteristics estimated value. Further, as shown in FIG. 10 (b), the target supply flow rate of the oxidant gas when in idle operation becomes Qₐᵢᵣ_{_{—}}_{idle}_{_{—}}_{ideal}[A] for the ideal I-V characteristics and Qₐᵢᵣ_{_{—}}_{idle}_{_{—}}ₑₐₜ[A] for the I-V characteristics estimated value.

Finally, target supply flow rate Qₐᵢᵣ_{_{—}}_{idle}[NL/min] for the oxidant gas supplied to fuel cell stack 19 that is for realizing idle power generation level G_{idle}[kW] is expressed as shown in said Formula (13).

[Formula 13]

Qₐᵢᵣ_{_{—}}_{idle}=Qₐᵢᵣ_{_{—}}_{idle}_{_{—}}ₑₛₜ (14)

The same method that was used in Embodiment 9 is used in Steps S3-S6 in FIG. 29 to calculate power consumption Wₐᵢᵣ_{_{—}}_{idle}′[kW] of the motor of oxidant gas supply device 3 at idle return time.

As explained above, for the fuel cell system pertaining to Embodiment 10, controller 14 further functions as the current/voltage characteristics estimation means for estimating the current/voltage characteristics of the fuel cell stack. The flow rate calculation means (controller 14) corrects the flow rate of the fluid (oxidant gas) that is required to realize idle operation based on the current/voltage characteristics estimated by the current/voltage characteristics estimation means. As a result, very accurate power consumption can be achieved.

The current/voltage characteristics estimation means (controller 14) estimates the current/voltage characteristics based on the temperature pertaining to fuel cell stack 19. As a result, the current/voltage characteristics of fuel cell stack 19 can be estimated in accordance with the temperature pertaining to fuel cell stack 19.

The current/voltage characteristics estimation means (controller 14) estimates the current/voltage characteristics from the total power generation time of fuel cell stack 19. As a result, the current/voltage characteristics of fuel cell stack 19 can be estimated in accordance with the deteriorating state of fuel cell stack 19.

The current/voltage characteristics are estimated from the relationship between the current and voltage drawn from fuel cell stack 19. And, since the current/voltage characteristics of fuel cell stack 19 are estimated by learning the relationship between the current and total voltage drawn from fuel cell stack 19 while the fuel cell system is in operation, the current/voltage characteristics of fuel cell stack 19 can be estimated in accordance with the state of fuel cell stack 19.

### Embodiment 11

As was the case with Embodiment 9, Embodiment 11 also uses oxidant gas supply device 3 to supply oxidant gas to fuel cell stack 19 as an example of a “fluid supply device (PP system auxiliary device)”.

The explanations pertaining to FIG. 28 and FIG. 29 are the same as those for Embodiment 9 and 10 and have therefore been omitted.

The summary of the operation is the same as that for Embodiment 9.

Next is provided an explanation of the method used to estimate the torque required by oxidant gas supply device 3 in Step S5 of FIG. 29, using FIG. 11.

The pressure Pₐᵢᵣ_{_{—}}_{stack}_{_{—}}ᵢₙ[kPa) of the oxidant gas at the cathode entrance of fuel cell stack 19 is detected by oxidant gas pressure sensor 10 and the pressure ratio Prₐᵢᵣ[−] of oxidant gas supply device 3, explained in Embodiment 9, is calculated according to formula (14) below from the atmospheric pressure Pᵢₙ_{_{—}}ₐᵢᵣ[kPa] detected at Step S1 of FIG. 29.

[Formula 14]

Prₐᵢᵣ=Pₐᵢᵣ_{_{—}}_{stack}_{_{—}}ᵢₙ/Pᵢₙ_{_{—}}ₐᵢᵣ (14)

In addition, Formula (4) representing motor load RLₐᵢᵣ[Nm] of oxidant gas supply device 3, which was described in Embodiment 9, is derived by previous experiments based on the relationship between the motor revolution speed Nₐᵢᵣ[rpm] of oxidant gas supply device 3 and the pressure ratio Prₐᵢᵣ[−] of oxidant gas supply device 3 and motor load RLₐᵢᵣ[Nm] of oxidant gas supply device 3 is calculated from the target revolution speed of the motor Nₐᵢᵣ_{_{—}}_{idle}′[rpm] after oxidant gas supply device 3 has been corrected when in idle operation as calculated at Step S4 in FIG. 29 and Formula (14).

The same calculation method that was used in Embodiments 9 and 10 is also used as the calculation method in Steps S3-S6 in FIG. 29 to calculate the power consumption Wₐᵢᵣ_{_{—}}_{idle}′[kW] of the motor of oxidant gas supply device 3 at idle return time.

### Embodiment 12

Embodiment 12 uses pure water supply device 7 to supply pure water for humidifying the oxidant gas supplied to fuel cell stack 19 as another example of a “fluid supply device (PP system auxiliary device)”.

The explanations pertaining to FIG. 2 through FIG. 3 and FIG. 29 are the same as those for Embodiment 9 and have therefore been omitted.

The summary of the operation is the same as that for Embodiment 9. For Embodiment 12 of the present invention, a fuel cell system is installed in a vehicle with fuel cell stack 19 as the main power source. When the state of the vehicle is determined to be in a predetermined idle state, the idle stopping means stops pure water supply device 7, stops power generation of fuel cell stack 19 and puts the vehicle in “idle stopped state”.

Next is provided an explanation of the method used to calculate the target supply flow rate of pure water supply device 7 at Step S2 in FIG. 29, using FIG. 17. As shown in FIG. 17, the relationship between the flow rate of the oxidant gas supplied to fuel cell stack 19 and the flow rate of the pure water that is used to humidify the oxidant gas is derived by previous experiments. The target supply flow rate of the pure water used to humidify the target supply flow rate Qₐᵢᵣ_{_{—}}_{idle}[L/min] of the oxidant gas when in idle operation, as explained in Embodiment 9, should be Q_{pwr}_{_{—}}_{idle}[L/min].

Next, using FIG. 17, an explanation is provided of one example of the method used to correct the target supply flow rate of pure water supply device 7 at Step S3 in FIG. 29. The relationship between the flow rate of the oxidant gas supplied to fuel cell stack 19 and the flow rate of the pure water that is used to humidify the oxidant gas is derived by previous experiments. The amount of correction in the target humidifying pure water supply flow rate when in idle operation that is used to humidify the target supply flow rate Qₐᵢᵣ_{_{—}}_{idle}′[L/min] for after the oxidant gas has been corrected when in idle operation, as explained in Embodiment 9, should be Q_{pwr}_{_{—}}_{idle}′[L/min].

In addition to the method explained here for calculating the target flow rate for after the correction has been made in pure water supply device 7 when in idle operation, another method, for example, would be to estimate the partial water vapor pressure of the intake oxidant gas from the temperature of the oxidant gas taken in by oxidant gas supply device 3, which is detected by temperature sensor 17, and then correct the target supply flow rate of pure water supply device 7 when in idle operation, based on this estimated value for the partial water vapor pressure.

Next is provided an explanation of the method used to calculate the motor revolution speed of pure water supply device 7 in Step S4 of FIG. 29, using FIG. 18.

The relationship between the motor revolution speed of pure water supply device 7, the supply flow rate of the pure water used for humidifying and the atmospheric pressure is derived by previous experiments. Based on this relationship, the motor revolution speed N_{pwr}_{_{—}}_{idle}[rpm] of pure water supply device 7 for when a supply flow rate of Q_{pwr}_{_{—}}_{idle}′[L/min] is supplied after the correction has been made and the atmospheric pressure is 1 atmosphere, and the motor revolution speed N_{pwr}_{_{—}}_{idle}′[rpm] for after the correction has been made in pure water supply device 7 for when a supply flow rate of Q_{pwr}_{_{—}}_{idle}′[L/min] is supplied after the pure water used for humidifying has been corrected and the atmospheric pressure detected at Step S1 in FIG. 29 is Pᵢₙ_{_{—}}ₐᵢᵣ[kPa], are calculated.

Next is provided an explanation of the method used to estimate the torque required by the motor of pure water supply device 7 in Step S5 of FIG. 29.

The motor revolution speed N_{pwr}_{_{—}}_{idle}′[rpm] for after the correction has been made in pure water supply device 7 when in idle operation becomes Tr_{pwr}_{_{—}}_{idle}′[Nm] for the required motor torque for pure water supply device 7 required at an output of t_{pwr}_{_{—}}_{idle}[sec] for normal idle return time, the load to the motor of pure water supply device 7 becomes RL_{pwr}[Nm] and the inertia for the motor of pure water supply device 7 becomes I_{pwr}[kg·m̂2]. Also, since motor load RL_{pwr}[Nm] for pure water supply device 7 is a function of the motor revolution speed N_{pwr}[rpm] and the pressure ratio Pr_{pwr}[−] of pure water supply device 7, it can be represented as shown in Formula (16).

[Formula 16]

RL_{pwr}=RL_{pwr}(N_{pwr},Pr_{pwr}) (16)

When the motor revolution speed N_{pwr}_{_{—}}_{idle}′[rpm] for after the correction has been made in pure water supply device 7 when in idle operation is converted to a motor angle speed of ω_{pwr}_{_{—}}_{idle}′[rad/sec], it can be represented according to Formula (17).

[Formula 17]

ω_{pwr}_{_{—}}_{idle}′=N_{pwr}_{_{—}}_{idle}′×(2×π)/60 (18)

In addition, the estimated value Tr_{pwr}_{_{—}}_{idle}′[Nm] of the required motor torque of pure water supply device 7 can be represented by Formula (38).

[Formula 38]

T_{pwr}_{_{—}}_{idle}′=Iω_{pwr}_{_{—}}_{idle}+RL_{pwr} (38)

Motor angle speed ω_{pwr}_{_{—}}_{idle}′[rad/sec] can further be represented by Formula (18).

[Formula 18]

ω_{pwr}_{_{—}}_{idle}′=∫₀^{pwr}^{_{—}}^{idle}(Tr_{pwr}_{_{—}}_{idle}′−RL_{pwr})/I_{pwr}·dt (18)

Formula (17) combined with Formula (19) becomes Formula (19).

[Formula 19]

N_{pwr}_{_{—}}_{idle}′×(2×π)/60=∫^{pwr}^{_{—}}^{idle}(Tr_{pwr}_{_{—}}_{idle}′−RL_{pwr})/I_{pwr}·dt (19)

Formula (20) can be further expanded into Formula (20-1) and Formula (20-2) to make Tr_{pwr}_{_{—}}_{idle}′=kt.

$$\begin{matrix}Formula ( 20 ) & \\ {N}_{pwr\_idle}^{′} \times ( 2 \times π ) / 60 = {[ \frac{{kt}^{2}}{2} \times \frac{1}{{I}_{pwr}} ]}_{0}^{{t}_{pwr\_idle}} - {\int }_{0}^{{t}_{pwr\_idle}} {RL}_{pwr} / {I}_{pwr} \cdot d t & ( 20 \text{-} 1 ) \\ k = ( {N}_{pwr\_idle}^{′} \times ( 2 \times π ) / 60 + {\int }_{0}^{{t}_{pwr\_idle}} {RL}_{pwr} / {I}_{pwr} \cdot d t ) \times 2 \times {I}_{pwr} / {t}_{pwr\_idle}^{2} & ( 20 \text{-} 2 )\end{matrix}$$

Therefore, since the required motor torque Tr_{pwr}_{_{—}}_{idle}′[Nm] of pure water supply device 7 for when a motor revolution speed of N_{pwr}_{_{—}}_{idle}′[rpm] is output after the correction has been made in pure water supply device 7 when in idle operation is “k” in Formula (20-2), the amount of change ΔTr_{pwr}_{_{—}}_{idle}′[Nm/sec] in the required torque for when said required torque is output at a normal idle return time of t_{pwr}_{_{—}}_{idle}[sec] is represented by Formula (21).

[Formula 21]

ΔTr_{pwr}_{_{—}}_{idle}′=(N_{pwr}_{_{—}}_{idle}′×(2×π)/60+∫^{pwr}^{_{idle}}RL_{pwr}/I_{pwr}·dt)×2×I_{pwr}/t_{pwr}_{_{—}}_{idle}² (21)

Finally, an explanation is provided for the method used to calculate the power consumption of the motor of pure water supply device 7 at Step S6 in FIG. 29, using FIG. 18.

The relationship between the motor revolution speed of pure water supply device 7, the torque, and the motor loss is derived by previous experiments. When the motor revolution speed for after the correction has been made in pure water supply device 7 when in idle operation is N_{pwr}_{_{—}}_{idle}′[rpm], and the estimated value for torque required by the motor of pure water supply device 7 is Tr_{pwr}_{_{—}}_{idle}′[Nm], the motor loss Loss_{pwr}_{_{—}}_{idle}′[kW] of pure water supply device 7 can be represented according to Formula (39).

[Formula 39]

Loss_{pwr}_{_{—}}_{idle}′=Loss_{pwr}_{_{—}}_{idle}(N_{pwr}_{_{—}}_{idle}′,Tr_{pwr}_{_{—}}_{idle}′) (39)

The power consumption W_{pwr}_{_{—}}_{idle}′[kW] of the motor of pure water supply device 7 at idle return time can be represented according to Formula (40).

[Formula 40]

W_{pwr}_{_{—}}_{idle}′=2×π×N_{pwr}_{_{—}}_{idle}′×Tr_{pwr}_{_{—}}_{idle}′/(60×1000)+Loss_{pwr}_{_{—}}_{idle}′ (40)

As explained above, for the fuel cell system pertaining to Embodiment 12, the fluid supply device is humidifying water supply device (pure water supply device 7) that supplies water for humidifying the oxidant gas supplied to fuel cell stack 19. The flow rate calculation means is a humidifying water flow rate calculation means that calculates the flow rate of the water that is required to realize idle operation, and the motor revolution speed calculation means calculates the motor revolution speed of the humidifying water supply device that is required to realize the flow rate of the water that was calculated by the humidifying water flow rate calculation means. And as a result, a very accurate power consumption of the motor of the humidifying water supply device (pure water supply device 7) can be achieved.

The fuel cell system further comprises an intake humidifying water pressure estimation means that estimates the pressure of the water taken in by the humidifying water supply device based on the atmospheric pressure, and a discharge humidifying water pressure detection means (pressure sensor 50) that detects the pressure of the water discharged by the humidifying water supply device. The torque estimation means calculates the pressure ratio between the pressure estimated by the intake humidifying water pressure estimation means and the pressure detected by the discharge humidifying water pressure detection means and corrects the torque based on said pressure ratio. In other words, it estimates the torque required by the motor of the humidifying pure water supply device required to realize the command value for the motor revolution speed for after the correction has been made at the predetermined idle return time, based on the aforementioned pressure ratio, and then estimates the power consumption of the motor of the humidifying water supply device from the motor revolution speed for after the correction has been made and the required torque. And, as a result, very accurate power consumption can be achieved.

### Embodiment 13

As was the case with Embodiment 12, Embodiment 13 also uses pure water supply device 7 to supply the pure water that humidifies the oxidant gas supplied to fuel cell stack 19 as another example of a “fluid supply device (PP system auxiliary device)”.

The explanations pertaining to FIG. 2 through FIG. 3, FIG. 28, and FIG. 29 are the same as those for Embodiment 9 and 12 and have therefore been omitted.

The summary of the operation is the same as that for Embodiment 12.

Next is provided an explanation of the method used to estimate the required torque of pure water supply device 7 in Step S5 of FIG. 29, using FIG. 20.

First, the pressure P_{pwr}_{_{—}}ᵢₙ[kPa] of the pure water taken in by pure water supply device 7 is obtained. The density of the pure water becomes P_{pwr}[kg/m̂3] and the water level from pure water reservoir 39 to pure water supply device 7 becomes h_{pwr}[m]. Measurements can be taken by installing a water level sensor inside of pure water reservoir 39, for example. The intake pure water pressure P_{pwr}_{_{—}}ᵢₙ[kPa] of pure water supply device 7 can be calculated from the atmospheric pressure Pᵢₙ_{_{—}}ₐᵢᵣ[kPa] detected at Step S1 in FIG. 29, as shown in Formula (23). In this Formula, “g” represents the acceleration of gravity [m/ŝ2].

[Formula 23]

P_{pwr}_{_{—}}ᵢₙ=P_{pwr}×g×h_{pwr}+Pᵢₙ_{_{—}}ₐᵢᵣ (23)

Then, pressure sensor 50, which detects the pressure of the pure water of pure water supply device 7, detects the pressure P_{pwr}_{_{—}}ₒᵤₜ[kPa] of the pure water discharged by pure water supply device 7 and calculates the pressure ratio Pr_{pwr}[−] of pure water supply device 7, as explained for Embodiment 12, from intake pure water pressure P_{pwr}_{_{—}}ᵢₙ[kPa] calculated in Formula (25) to obtain Formula (24).

[Formula 24]

Pr_{pwr}=P_{pwr}_{_{—}}ₒᵤₜ/P_{pwr}_{_{—}}ᵢₙ (24)

Then, Formula (16), which represents motor load RL_{pwr}[Nm] of pure water supply device 7, as explained for Embodiment 12, is derived by previous experiments from the relationship between motor revolution speed N_{pwr}[rpm] of pure water supply device 7 and pressure ratio Pr_{pwr}[−] of pure water supply device 7 and motor load RL_{pwr}[Nm] of pure water supply device 7 is calculated from Formula (26) and motor revolution speed N_{pwr}_{_{—}}_{idle}′[rpm] for after the correction has been made in pure water supply device 7 when in idle operation, as calculated in Step S4 of FIG. 29.

The same method that was used for Embodiment 9 and 12 can be used for the arithmetic calculations used in Steps S3-S6 of FIG. 29 to calculate the power consumption W_{pwr}_{_{—}}_{idle}′[kW] of the motor of pure water supply device 7 at idle return time.

### Embodiment 14

For Embodiment 14, cooling liquid supply device (cooling water supply device) 37, which supplies cooling liquid (cooling water) for cooling fuel cell stack 19 is used as yet another example of a “fluid supply device (PP system auxiliary device)”.

The explanations pertaining to FIG. 2 through FIG. 3 and FIG. 29 are the same as those for Embodiment 9 and have therefore been omitted.

The summary of the operation is the same as that for Embodiment 14. For Embodiment 14 of the present invention, a fuel cell system is installed in a vehicle with fuel cell stack 19 as the main power source. When the state of the vehicle is determined to be in a predetermined idle state, the idle stopping means stops cooling water supply device 37, or stops power generation of fuel cell stack 19 due to low electrode load operation and puts it in “idle stopped state”.

Next, an explanation is provided of the method used to calculate the target supply flow rate of cooling water supply device 37 when in idle operation for Step S2 in FIG. 29, using FIG. 22. The relationship between the amount of power generated by fuel cell stack 19 and the cooling water flow rate for cooling fuel cell stack 19 is derived by previous experiments. In addition, the supply flow rate of the cooling water for when fuel cell stack 19 is generating an idle power generation level of G_{idle}[kW], as explained in Embodiment 9, should be Q_{stack}_{_{—}}_{llc}_{_{—}}_{idle}[l/min].

Next, an explanation is provided for one example of a method for correcting the supply flow rate of cooling water supply device 37 when in idle operation for Step S3 in FIG. 29, using FIG. 22. For example, a correction is made to increase the operating point of the PP system auxiliary device for when in idle operation due to a decrease in the atmospheric pressure and as a result, the amount of power consumed by the PP system auxiliary device increases, so when the amount of idle power generation that must be generated by fuel cell stack 19 is increased to G_{idle}′[kW], the supply flow rate for after the correction has been made in the cooling water when in idle operation becomes Q_{stack}_{_{—}}_{llc}_{_{—}}_{idle}[L/min].

Next is provided an explanation of the method used to calculate the motor revolution speed of cooling water supply device 37 for Step S4 in FIG. 29, using FIG. 23. The relationship between the motor revolution speed of cooling water supply device 37, the supply flow rate of the cooling water and the atmospheric pressure is derived by previous experiments. Based on this relationship, the motor revolution speed N_{stack}_{_{—}}_{llc}_{_{—}}_{idle}[rpm] for when a supply flow rate of Q_{stack}_{_{—}}_{llc}_{_{—}}_{idle}′[L/min] is supplied after the correction has been made in the cooling water and the atmospheric pressure is 1 atmosphere, and the motor revolution speed N_{stack}_{_{—}}_{llc}_{_{—}}_{idle}′[rpm] for after the correction has been made and a supply flow rate of Q_{stack}_{_{—}}_{llc}_{_{—}}_{idle}′[L/min] is supplied after the correction has been made in the cooling water, and the atmospheric pressure detected at Step S1 in FIG. 29 is Pᵢₙ_{_{—}}ₐᵢᵣ[kPa] are calculated.

Next is provided an explanation of the method used to estimate the torque required by the motor of cooling water supply device 37 at Step S5 of FIG. 29.

The motor revolution speed N_{stack}_{_{—}}_{llc}_{_{—}}_{idle}′[rpm] for after the correction has been made in cooling water supply device 37 becomes Tr_{stack}_{_{—}}_{llc}_{_{—}}_{idle}′[Nm] for the required motor torque for cooling water supply device 37 required at an output of t_{stack}_{_{—}}_{llc}_{_{—}}_{idle}[sec] for normal idle return time, the load to the motor of cooling water supply device 37 becomes RL_{stack}_{_{—}}_{llc}[Nm] and the inertia for the motor of cooling water supply device 37 becomes I_{stack}_{_{—}}_{llc}[kg·m̂2]. And, since the motor load RL_{stack}_{_{—}}_{llc}[Nm] for cooling water supply device 37 is a function of the motor revolution speed N_{stack}_{_{—}}_{llc}[rpm] and the pressure ratio Pr_{stack}_{_{—}}_{llc}[−] of cooling water supply device 37, it can be expressed according to Formula (26).

[Formula 26]

RL_{stack}_{_{—}}_{llc}=RL_{stack}_{_{—}}_{llc}(N_{stack}_{_{—}}_{llc},Pr_{stack}_{_{—}}_{llc}) (26)

In addition, when the motor revolution speed N_{stack}_{_{—}}_{llc}_{_{—}}_{idle}′[rpm] for after the correction has been made in cooling water supply device 37 is converted to a motor angle speed of ω_{stack}_{_{—}}_{llc}_{_{—}}_{idle}′[rad/sec], it is as shown in Formula (27).

[Formula 27]

ω_{stack}_{_{—}}_{llc}_{_{—}}_{idle}′=N_{stack}_{_{—}}_{llc}_{_{—}}_{idle}′×(2×π)/60 (27)

Furthermore, the estimated value Tr_{stack}_{_{—}}_{llc}_{_{—}}_{idle}′[Nm] of the torque required by the motor of cooling water supply device 37 can be expressed as Formula (41).

[Formula 41]

Tr_{stack}_{_{—}}_{llc}_{_{—}}_{idle}′=I\dot{ω}_{stack}_{_{—}}_{llc}_{_{—}}_{idle}+RL_{stack}_{_{—}}_{llc} (41)

Furthermore, motor angle speed ω_{stack}_{_{—}}_{lld}_{_{—}}_{idle}′[rad/sec] can be expressed as Formula (28).

[Formula 28]

ω_{stack}_{_{—}}_{llc}_{_{—}}_{idle}′=∫₀^{stack}^{_{—}}^{llc}^{_{—}}^{idle}ITr_{stack}_{_{—}}_{llc}_{_{—}}_{idle}′−RL_{stack}_{_{—}}_{llc})/I_{slack}_{_{—}}_{llc}·dt (28)

[Formula 29]

N_{stack}_{_{—}}_{llc}_{_{—}}_{idle}′×(2×π)/60=∫₀^{stack}^{_{—}}^{llc}^{_{—}}^{idle}(Tr_{stack}_{_{—}}_{llc}_{_{—}}_{idle}′−RL_{stack}_{_{—}}_{llc})/I_{stack}_{_{—}}_{llc}·dt (29)

In addition, when expanding the right side of Formula (31) to make Tr_{stack}_{_{—}}_{llc}_{_{—}}_{idle}′=kt, it is expressed as shown in Formulae (30-1) and (30-2).

$$\begin{matrix}Formula ( 30 ) & \\ {N}_{stack\_llc \_idle}^{′} \times ( 2 \times π ) / 60 = {[ \frac{{kt}^{2}}{2} \times \frac{1}{{I}_{stack\_llc}} ]}_{0}^{{t}_{stack\_llc \_idle}} - {\int }_{0}^{{t}_{stack\_llc \_idle}} {RL}_{stack\_llc} / {I}_{stack\_llc} \cdot d t & ( 30 \text{-} 1 ) \\ k = ( {N}_{stack\_llc \_idle}^{′} \times ( 2 \times π ) / 60 + {\int }_{0}^{{t}_{stack\_llc \_idle}} {RL}_{stack\_llc} / {I}_{stack\_llc} \cdot d t ) \times 2 \times {I}_{stack\_llc} / {t}_{stack\_llc \_idle}^{2} & ( 30 \text{-} 2 )\end{matrix}$$

Therefore, since the required motor torque Tr_{stack}_{_{—}}_{llc}_{_{—}}_{idle}′[Nm] for when a motor revolution speed of N_{stack}_{_{—}}_{llc}_{_{—}}_{idle}′[rpm] is output after the correction has been made in cooling water supply device 37 is “k” in Formula (30-2), the amount of change ΔTr_{stack}_{_{—}}_{llc}_{_{—}}_{idle}′[Nm/sec] in the required torque for when said required torque is output at a normal idle return time of t_{stack}_{_{—}}_{llc}_{_{—}}_{idle}[sec] can be represented according to Formula (31).

[Formula 31]

ΔTr_{_{—}}_{stack}_{_{—}}_{llc}_{_{—}}_{idle}′=(N_{stack}_{_{—}}_{llc}_{_{—}}_{idle}′×(2×π)/60+∫₀^{stack}^{_{—}}^{llc}^{_{—}}^{idle}RL_{stack}_{_{—}}_{llc}/I_{stack}_{_{—}}_{llc}·dt)×2×I_{stack}_{_{—}}_{llc}/t_{stack}_{_{—}}_{llc}_{_{—}}_{idle}² (31)

Finally, an explanation is provided for the method used to calculate the power consumption of the motor of cooling water supply device 37 at Step S6 in FIG. 29, using FIG. 20.

The relationship between the motor revolution speed of cooling water supply device 37, the torque, and the motor loss are derived by previous experiments. When the motor revolution speed for after the correction has been made in cooling water supply device 37 when in idle operation is N_{stack}_{_{—}}_{llc}_{_{—}}_{idle}′[rpm], and the estimated value of the torque required by the motor of cooling water supply device 37 is Tr_{stack}_{_{—}}_{llc}_{_{—}}_{idle}′[Nm], the motor loss, Loss_{stack}_{_{—}}ₗₗₑ_{_{—}}_{idle}′[kW], of cooling water supply device 37 can be represented according to Formula (42).

[Formula 42]

Loss_{stack}_{_{—}}_{llc}_{_{—}}_{idle}′=Loss_{stack}_{_{—}}_{llc}_{_{—}}_{idle}(N_{stack}_{_{—}}_{llc}_{_{—}}_{idle},Tr_{stack}_{_{—}}_{llc}_{_{—}}_{idle}′) (42)

The power consumption W_{stack}_{_{—}}_{llc}_{_{—}}_{idle}′[kW] of the motor of cooling water supply device 37 at idle return time can be expressed according to Formula (43).

[Formula 43]

W_{stack}_{_{—}}_{llc}_{_{—}}_{idle}′=2×π×N_{stack}_{_{—}}_{llc}_{_{—}}_{idle}×Tr_{stack}_{_{—}}_{llc}_{_{—}}_{idle}′(60×1000)+Loss_{stack}_{_{—}}_{llc}_{_{—}}_{idle} (43)

As explained above, for the fuel cell system pertaining to Embodiment 14, the fluid supply device is a cooling liquid supply device (cooling water supply device 37) that supplies cooling liquid (cooling water) for cooling fuel cell stack 19. In addition, the flow rate calculation means (Controller 14) is the cooling liquid flow rate calculation means that calculates the flow rate of the cooling liquid that is required to realize idle operation. And, the motor revolution speed calculation means calculates the motor revolution speed of said cooling water supply device that is required to realize the flow rate of the cooling liquid that was calculated by the cooling liquid flow rate calculation means. In other words, it corrects the motor revolution speed of the cooling liquid supply device that realizes the target flow rate of the cooling liquid that cools the fuel cell stack based on the atmospheric pressure and estimates the power consumption based on the motor revolution speed for after the correction has been made. As a result, a very accurate return time can be achieved.

The fuel cell system further comprises an intake cooling liquid pressure estimation means that estimates the pressure of the cooling liquid taken in by the cooling liquid supply device based on the atmospheric pressure, and discharge cooling liquid pressure detection means (pressure sensor 51) that detects the pressure of the cooling liquid discharged by the cooling liquid supply device. The torque estimation means calculates the pressure ratio of the pressure estimated by the intake cooling liquid pressure estimation means and the pressure detected by the discharge cooling liquid pressure detection means and corrects the torque based on the pressure ratio. In other words, it estimates the torque required by the motor of the cooling water supply device that is required to realize the command value of the motor revolution speed for after the correction has been made at a predetermined idle return time based on the aforementioned pressure ratio, and estimates the power consumed by the motor of the cooling water supply device from said required torque and the motor revolution speed for after the correction has been made. As a result, very accurate power consumption can be achieved.

### Embodiment 15

For Embodiment 15, cooling liquid supply device (cooling water supply device) 37, which supplies cooling liquid (cooling water) for cooling fuel cell stack 19 is used as yet another example of a “fluid supply device (PP system auxiliary device)”.

The explanations pertaining to FIG. 2 through FIG. 3, FIG. 29, and FIG. 22 are the same as those for Embodiment 9 and 14 and have therefore been omitted.

The summary of the operation is the same as that for Embodiment 14.

Next is provided an explanation of the method used to estimate the required torque for cooling water supply device 37 in Step S5 of FIG. 29, using FIG. 25.

First, the pressure P_{stack}_{_{—}}_{llc}_{_{—}}ᵢₙ[kpa] of the cooling water taken in by cooling water supply device 37 is obtained. The density of the cooling water becomes P_{stack}_{_{—}}_{llc}[kg/m̂3] and the water level from cooling water reservoir 40 to cooling water supply device 37 becomes h_{stack}_{_{—}}_{llc}[m]. Water level h_{stack}_{_{—}}_{llc}[m] can be measured by installing a water level sensor inside of cooling water reservoir 40, for example. Intake cooling water pressure P_{stack}_{_{—}}_{llc}_{_{—}}ᵢₙ[kPa] of cooling water supply device 37 can be calculated from atmospheric pressure water level Pᵢₙ_{_{—}}ₐᵢᵣ[kPa] detected at Step S1 in FIG. 29, as shown in Formula (33). In this formula, the acceleration of gravity is expressed as g [m/ŝ2].

[Formula 33]

P_{stack}_{_{—}}_{llc}_{_{—}}ᵢₙ=P_{stack}_{_{—}}_{llc}×g×h_{stack}_{_{—}}_{llc}+Pᵢₙ_{_{—}}ₐᵢᵣ (36)

Next, the pressure P_{stack}_{_{—}}_{llc}_{_{—}}ₒᵤₜ[kPa] of the cooling water discharged by cooling water supply device 37 is detected by pressure sensor 51, which detects the pressure of the cooling water of cooling water supply device 37. The pressure ratio Pr_{stack}_{_{—}}_{llc}[−] of cooling water supply device 37, which was explained in Embodiment 14, can be calculated from the intake cooling water pressure P_{stack}_{_{—}}_{llc}_{_{—}}ᵢₙ[kPa] calculated in Formula (34), as shown in Formula (34).

[Formula 34]

P_{stack}_{_{—}}_{llc}=P_{stack}_{_{—}}_{llc}_{_{—}}ₒᵤₜ/P_{stack}_{_{—}}_{llc}_{_{—}}ᵢₙ (34)

Next, Formula (27), which expresses the motor load RL_{stack}_{_{—}}_{llc}[Nm] for cooling water supply device 37 explained in Embodiment 14 is derived by previous experiments from the relationship between the motor revolution speed N_{stack}_{_{—}}_{llc}[rpm] of cooling water supply device 37 and the pressure ratio Pr_{stack}_{_{—}}_{llc}[−] of cooling water supply device 37. Motor load RL_{stack}_{_{—}}_{llc}[Nm] for cooling water supply device 37 is calculated from the motor revolution speed N_{stack}_{_{—}}_{llc}_{_{—}}_{idle}′[rpm] for after the correction has been made in cooling water supply device 37, which was calculated at Step S4 in FIG. 29 and Formula (31).

The same method that was used for Embodiments 9 and 12 can be used for the arithmetic calculation used in Steps S3-S6 in FIG. 29 to calculate the power consumption W_{pwr}_{_{—}}_{idle}′[kW] of the motor of cooling water supply device 37 at idle return time.

### Embodiment 16

Embodiment 16 uses oxidant gas supply device 3, pure water supply device 7 and cooling water supply device 37 as the “fluid supply device (PP system auxiliary device)”.

The explanations pertaining to FIG. 1 through FIG. 25 are the same as those for Embodiment 9 through 15 and have therefore been omitted.

The summary of the operation is the same as that for Embodiment 9 through 15.

Next is provided an explanation of the method used to estimate the power consumption of the auxiliary device for the fuel cell system at the idle return time for Step S6 in FIG. 29. The power consumption W_{ppsystem}_{_{—}}_{idle}′[kW] of the motor of the auxiliary device for the fuel cell system at idle return time is derived from the power consumption Wₐᵢᵣ_{_{—}}_{idle}′[kW] of the motor of oxidant gas supply drive 3, as explained in Embodiment 9, the power consumption W_{pwr}_{_{—}}_{idle}′[kW] of the motor of pure water supply device 7, as explained in Embodiment 12, and the power consumption W_{stack}_{_{—}}_{llc}_{_{—}}_{idle}′[kW] of the motor of cooling water supply device 37, as explained in Embodiment 14, as shown in Formula (44).

[Formula 44]

W_{PPsystem}_{_{—}}_{idle}′=Wₐᵢᵣ_{_{—}}_{idle}′+Wₐᵢᵣ_{_{—}}_{idle}′+W_{stack}_{_{—}}_{llc}_{_{—}}_{idle}′ (44)

### Other Embodiments

As explained above, the present invention was described using Embodiments 1 through 16, but it should not be interpreted that this invention is limited to the description or drawings in any part of this disclosure. In addition, it is obvious from this disclosure that any other form of implementation, embodiment or operating technology could be conceived by a person skilled in the art. In other words, it should be interpreted that the present invention encompasses various other embodiments not described herein. Therefore, the present invention is only limited to specific items of the invention pertaining to the appropriate scope of claims disclosed by the present invention.

### CONCLUSION

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

1. A fuel cell system, comprising:
a fuel cell that generates power from a fuel gas and an oxidant gas;
means for stopping an idle operation state of the fuel cell, by stopping a power generation of the fuel cell and placing the fuel cell in an idle stopped state;
means for detecting an atmospheric pressure at a periphery of the fuel cell; and
means for estimating an idle return time from when the fuel cell is in the idle stopped state until the fuel cell returns to the idle operation state based on the atmospheric pressure detected by the means for detecting an atmospheric pressure.

2.-13. (canceled)

14. A method for operating a fuel cell system, comprising:
detecting an atmospheric pressure at a periphery of a fuel cell; and
estimating an idle return time for the fuel cell based on the atmospheric pressure, wherein the idle return time is the time the fuel cell requires to return to an operating state from an idle stopped state.

15. The method of claim 14, further comprising:
supplying a fluid to the fuel cell with a fluid supply device, wherein the fluid supply device supplies the fluid to the fuel cell with a rotation of a motor;
calculating a flow rate of the fluid required to realize the operation state;
setting a motor revolution speed of the fluid supply device required to realize the calculated flow rate of the fluid;
correcting the motor revolution speed in accordance with the atmospheric pressure; and
estimating the idle return time based on the motor revolution speed after correcting the motor revolution speed.

16. The method of claim 15, wherein the fluid supply device is an oxidant gas supply device that supplies an oxidant gas to the fuel cell.

17. The method of claim 16, further comprising:
detecting a temperature of the oxidant gas that is taken in by the oxidant gas supply device;
estimating a density of the oxidant gas taken in by the oxidant gas supply device based on the temperature and the atmospheric pressure; and
correcting the motor revolution speed in accordance with the estimated density of the oxidant gas.

18. The method of claim 16, further comprising:
detecting a pressure of oxidant gas discharged by the oxidant gas supply device;
calculating a pressure ratio of the atmospheric pressure and the oxidant gas pressure;
correcting the motor revolution speed in accordance with the pressure ratio; and
estimating the idle return time based on the motor revolution speed after correcting the motor revolution speed.

19. The method of claim 15, wherein the fluid supply device is a humidifying water supply device for supplying water used to humidify the oxidant gas supplied to the fuel cell.

20. The method of claim 19, further comprising:
estimating an intake water pressure of water taken in by the humidifying water supply device based on the atmospheric pressure;
detecting a discharge humidifying water pressure of water discharged by the humidifying water supply device;
calculating a pressure ratio between the estimated intake humidifying water pressure and the discharge humidifying water pressure;
correcting the motor revolution speed in accordance with the pressure ratio; and
estimating the idle return time based on the motor revolution speed after correcting the motor revolution speed.

21. The method of claim 15, wherein the fluid supply device is a cooling liquid supply device that supplies cooling liquid for cooling the fuel cell.

22. The method of claim 21, further comprising:
estimating an intake cooling liquid pressure taken in by the cooling liquid supply device;
detecting a discharge cooling liquid pressure discharged by the cooling liquid supply device;
calculating a pressure ratio between the estimated intake cooling liquid pressure and the discharge cooling liquid pressure;
correcting the motor revolution speed in accordance with the pressure ratio; and
estimating the idle return time based on the motor revolution speed after correcting the motor revolution speed.

23. The method of claim 16, further comprising:
estimating one or more current/voltage characteristics of the fuel cell;
correcting the motor revolution speed in accordance with the one or more current/voltage characteristics; and
estimating the idle return time based on the motor revolution speed after correcting the motor revolution speed.

24. The method of claim 23, wherein estimating one or more current/voltage characteristics of the fuel cell further comprises estimating the one or more current/voltage characteristics based on a temperature of the fuel cell.

25. The method of claim 23, wherein estimating one or more current/voltage characteristics of the fuel cell further comprises estimating the one or more current/voltage characteristics based on a total power generation of the fuel cell.

26. The method of claim 23, wherein estimating one or more current/voltage characteristics of the fuel cell further comprises estimating the one or more current/voltage characteristics based on a relationship between a current and a voltage drawn from the fuel cell.

27. The method of claim 14, wherein the operating state is an idle operation state.

28. The method of claim 14, further comprising:
stopping power generation by a fuel cell in an idle operation state and placing the fuel cell in the idle stopped state.

29. A fuel cell system, comprising:
a fuel cell that generates power from a fuel gas and an oxidant gas;
an atmospheric pressure detector; and
a controller adapted to stop power generation of the fuel cell and place the fuel cell in an idle stopped state and to estimate an idle return time; wherein the estimated idle return time is the time required to return the fuel cell to an idle operation state from the idle stopped state.

30. The fuel cell system of claim 29, further comprising:
a fluid supply device that supplies a fluid to the fuel cell due to rotation of a motor;
wherein the controller is adapted to calculate a flow rate of the fluid that is required to realize the idle operation state, calculate a revolution speed of the motor for the fluid supply device to realize the calculated flow rate, correct the motor revolution speed based on the atmospheric pressure, and estimate the idle return time based on the corrected motor revolution speed.

31. The fuel cell system of claim 30, wherein the fluid supply device is an oxidant gas supply device that supplies the oxidant gas to the fuel cell.

32. The fuel cell system of claim 31, further comprising:
an oxidant gas temperature detector that detects a temperature of the oxidant gas input to the oxidant gas supply device; and
wherein the controller is adapted to estimate a density of the oxidant gas taken in by the oxidant gas supply device based on the temperature and the atmospheric pressure; and
wherein the controller is adapted to correct the motor revolution speed in accordance with the estimated density of the oxidant gas.

33. The fuel cell system of claim 31, further comprising:
an oxidant gas pressure detector that detects an oxidant gas pressure of the oxidant gas discharged by the oxidant gas supply device;
wherein the controller is adapted to calculate a pressure ratio of the atmospheric pressure and the oxidant gas pressure, correct the motor revolution speed in accordance with the pressure ratio, and estimate the idle return time based on the corrected motor revolution speed.

34. The fuel cell system of claim 30, wherein the fluid supply device is a humidifying water supply device for supplying water used to humidify the oxidant gas supplied to the fuel cell.

35. The fuel cell system of claim 34, further comprising:
a humidifying water discharge pressure detector that detects a pressure of the water discharged by the humidifying water supply device;
wherein the controller is adapted to estimate a humidifying water intake pressure based on the atmospheric pressure;
wherein the controller is further adapted to calculate a pressure ratio between the humidifying water intake pressure and the pressure of the water discharged by the humidifying water discharge pressure detector, correct the motor revolution speed in accordance with the pressure ratio, and estimate the idle return time based on the corrected motor revolution speed.

36. The fuel cell system of claim 30, wherein the fluid supply device is a cooling liquid supply device that supplies cooling liquid for cooling the fuel cell.

37. The fuel cell system of claim 36, further comprising:
a discharge cooling liquid pressure detector that detects a discharge cooling liquid pressure of the cooling liquid discharged by the cooling liquid supply device;
wherein the controller is adapted to estimate an intake cooling liquid pressure of the cooling liquid taken in by the cooling liquid supply device;
wherein the controller is further adapted to calculate a pressure ratio between the estimated intake cooling liquid pressure and the detected discharge cooling liquid pressure, correct the motor revolution speed in accordance with the pressure ratio, and estimate the idle return time based on the corrected motor revolution speed.

38. The fuel cell system of claim 31, wherein the controller is adapted to estimate one or more current/voltage characteristics of the fuel cell; and
wherein the controller is further adapted to correct the motor revolution speed in accordance with the one or more estimated current/voltage characteristics and to estimate the idle return time based on the corrected motor revolution speed.

39. The fuel cell system of claim 38, wherein the controller is adapted to estimate the one or more current/voltage characteristics based on a temperature of the fuel cell.

40. The fuel cell system of claim 38, wherein the controller is adapted to estimate the one or more current/voltage characteristics from a total power generation of the fuel cell.

41. The fuel cell system of claim 38, wherein the controller is adapted to estimate the one or more current/voltage characteristics of the fuel cell from a relationship between a current and a voltage drawn from the fuel cell.

42.-88. (canceled)
